(19) United States
(12) Patent Application Publication
(10) Pub. No.: US 2024/0242269 A1
(43) Pub. Date: Jul. 18, 2024

(54) UTILIZING A DEPOSIT TRANSACTION PREDICTOR MODEL TO DETERMINE FUTURE NETWORK TRANSACTIONS

(71) Applicant: Chime Financial, Inc., San Francisco, CA (US)

(72) Inventors: Elle Creel, San Francisco, CA (US); Ankit Jain, Mission Viejo, CA (US); Aoni Wang, Redwood City, CA (US); Carl Cummings, San Francisco, CA (US); Daniel Cash, Charlotte, NC (US); Di Mo, Mountain View, CA (US); James Sheak, San Mateo, CA (US); Meeri Shin, San Francisco, CA (US); Michael Homnick, San Francisco, CA (US); Michael Stumpo, Oakland, CA (US); Polina Munoz, San Francisco, CA (US); Victoria Palmiotto, Oakland, CA (US); Xuanxing Xiong, Santa Clara, CA (US); Yiyang Zeng, Everett, MA (US); Akhil Naini, New York, NY (US)

(21) Appl. No.: 18/153,703

(22) Filed: Jan. 12, 2023

(51) Int. Cl. G06Q 40/02

(52) U.S. Cl. CPC G06Q 40/02

(57) ABSTRACT

The disclosure describes embodiments of systems, methods, and non-transitory computer readable storage media that utilize a deposit transaction predictor model to facilitate downstream access to deposit transaction prediction data through a data pipeline. For instance, the disclosed systems can enable universal access to deposit transaction prediction data to various downstream services by utilizing a data pipeline that identifies data for a user account from various data sources, transforming the data into deposit transaction prediction data utilizing a deposit transaction predictor model, and updating a deposit transaction prediction data source with the deposit transaction prediction data. For instance, the disclosed systems can utilize the deposit transaction predictor model to analyze various user account data to determine patterns that indicate deposit transaction prediction data. Furthermore, the disclosed systems can enable access to the deposit transaction prediction data from the deposit transaction prediction data source by downstream services through various data requests.

### BACKGROUND

Recent years have seen a significant development in systems that utilize web-based and mobile-based applications to manage user accounts and digital information for user accounts in real time. For example, many conventional applications provide various graphical user interfaces (GUIs) to present digital information and options to client devices. This often includes various conventional systems utilizing data transformation pipelines to manage data and implement data functionalities within the conventional applications. Although conventional systems attempt to determine and communicate digital information to user accounts and conventional applications through such data transformation pipelines, such conventional systems face a number of technical shortcomings, particularly with regard to data pipelines that rigidly, inefficiently, and inaccurately determine and communicate digital information to user accounts and conventional applications.

For example, many conventional systems cannot robustly (or flexibly) transform deposit transaction data of a user account to enable insightful applications from the deposit transaction data. More specifically, many conventional data pipelines do not provide insights into future deposit transactions of a user account to enable insightful applications catered towards anticipated deposit transactions. Rather, many conventional data pipelines utilize or enable access to only pre-existing deposit transaction data for a user account.

In some cases, conventional applications may utilize user account data to predict or determine other types of future behaviors of user accounts, however, these conventional applications lack data management and data modelling efficiency. For example, some conventional systems cannot enable a wide variety of downstream computer network services to determine and/or access future behaviors of the user. Accordingly, many conventional systems analyze data of a user account to determine other types of future behaviors of the user account locally. Oftentimes, a local analysis of data leads to multiple computer networks and/or multiple devices inefficiently utilizing computing resources in an attempt to determine various future behaviors for a user account. To illustrate, oftentimes, such a local analysis approach requires computations at multiple systems and/or devices. Furthermore, utilizing a local analysis of data to determine various future behaviors for a user account often requires an increased amount of data transfers (i.e., an increase in bandwidth and storage of data at multiple locations) to systems and devices for analyzing and determining various future behaviors of the user account.

Additionally, many conventional systems often utilize incomplete or partial data to determine inaccurate future behavioral data of user accounts. In particular, many conventional systems rely on locally available data that may overlook (or neglect) portions of unavailable user account activity that factors into a future behavior predictions. Accordingly, such conventional systems are often unable to accurately determine predict user behaviors for user accounts from partial data.

### SUMMARY

The disclosure describes one or more embodiments of systems, methods, and non-transitory computer-readable media that utilize a deposit transaction predictor model to facilitate downstream access to deposit transaction prediction data through a data pipeline. For instance, the disclosed systems can enable universal access to deposit transaction prediction data to various downstream computer network services by utilizing a data pipeline that identifies data for a user account from various data sources, transforming the data into deposit transaction prediction data utilizing a deposit transaction predictor model, and updating a deposit transaction prediction data source with the deposit transaction prediction data. For instance, the disclosed systems can utilize the deposit transaction predictor model to analyze various user account data to determine patterns that indicate deposit transaction prediction data (e.g., time-based and value-based deposit transaction prediction data). Furthermore, in one or more implementations, the disclosed systems enable access to the deposit transaction prediction data from the deposit transaction prediction data source by downstream computer network services through one or more universal (or standardized) data requests.

### BRIEF DESCRIPTION OF THE DRAWINGS

The detailed description is described with reference to the accompanying drawings in which:

FIG. 1 illustrates a schematic diagram of an environment for implementing an inter-network facilitation system and a digital deposit transaction modeling system in accordance with one or more implementations.

FIG. 2 illustrates an overview of a digital deposit transaction modeling system facilitating a data pipeline that determines and provides access to deposit transaction prediction data in accordance with one or more implementations.

FIG. 3 illustrates an exemplary environment in which a digital deposit transaction modeling system utilizes a deposit predictor data pipeline job in accordance with one or more implementations.

FIG. 4 illustrates a digital deposit transaction modeling system utilizing a deposit transaction predictor model in accordance with one or more implementations.

FIG. 5 illustrates a flow diagram in which a digital deposit transaction modeling system updates a deposit transaction prediction data source(s) with determined deposit transaction data predictions in accordance with one or more implementations.

FIG. 6 illustrates an exemplary deposit transaction prediction data request utilized by a digital deposit transaction modeling system in accordance with one or more implementations.

FIG. 7 illustrates a flowchart of series of acts for utilizing a deposit transaction predictor model to facilitate downstream access to deposit transaction prediction data through a data pipeline in accordance with one or more implementations.

FIG. 8 illustrates a block diagram of an exemplary computing device in accordance with one or more implementations.

FIG. 9 illustrates an example environment for an inter-network facilitation system in accordance with one or more implementations.

### DETAILED DESCRIPTION

The disclosure describes one or more embodiments of a digital deposit transaction modeling system that utilizes a deposit transaction predictor model to determine deposit transaction prediction data for user accounts and enable universal access for the deposit transaction prediction data to downstream computer network services through a data pipeline.

In particular, the digital deposit transaction modeling system can identify user account data from various data sources as part of a data pipeline. Subsequently, the digital deposit transaction modeling system can analyze the user account data utilizing a deposit transaction predictor model to determine deposit transaction predictions for a user account. Indeed, in one or more implementations, the digital deposit transaction modeling system can determine deposit transaction prediction data, such as time-based deposit prediction data and value-based deposit prediction data. Moreover, the digital deposit transaction modeling system can continuously update a deposit transaction prediction data source with the deposit transaction prediction data to facilitate universal access to the deposit transaction prediction data on a user-to-user account basis to a variety of downstream computer network services (or applications) in real time (or near-real time).

In one or more implementations, the digital deposit transaction modeling system utilizes a deposit transaction prediction data pipeline to execute and facilitate various functionalities of a deposit transaction predictor model and downstream access to deposit transaction prediction data. As part of the deposit transaction prediction data pipeline, the digital deposit transaction modeling system can identify (or receive) user account data from one or more data sources (e.g., online and/or offline data storage services that track, collect, and/or store data for user accounts). In some cases, the user account data can include, but is not limited to, historical deposit transaction data corresponding to user accounts, geo-location data from client devices corresponding to the user accounts, or deposit transaction source information corresponding to the user accounts. Furthermore, the digital deposit transaction modeling system can also utilize a deposit transaction predictor model as part of the data pipeline to transform the user account data into deposit transaction prediction data. Indeed, the digital deposit transaction modeling system can update a deposit transaction prediction data source with the deposit transaction prediction data for the user accounts (for access at downstream services or applications).

As mentioned above, the digital deposit transaction modeling system, as part of a deposit transaction prediction data pipeline, can utilize a deposit transaction predictor model. In one or more embodiments, the digital deposit transaction modeling system utilizes user account data as input into the deposit transaction predictor model to generate deposit transaction prediction data that indicates future deposit transaction dates and values for user accounts. In particular, the digital deposit transaction modeling system utilizes the deposit transaction predictor model to analyze user account data, such as, but is not limited to, historical deposit transaction data corresponding to user accounts, geo-location data from client devices corresponding to the user accounts, or deposit transaction source information corresponding to the user accounts to determine deposit transaction patterns.

Indeed, in some embodiments, the digital deposit transaction modeling system utilizes the deposit transaction predictor model to determine deposit transaction patterns from historical deposit transaction data corresponding to user accounts as value-based deposit transaction prediction data and/or time-based deposit transaction prediction data. To illustrate, in some cases, the digital deposit transaction modeling system can utilize the deposit transaction predictor model with user account data to determine a predicted date for a predicted deposit transaction and/or a predicted frequency for predicted deposit transactions (as the time-based deposit prediction data). Moreover, in some instances, the digital deposit transaction modeling system can utilize the deposit transaction predictor model with user account data to determine a predicted deposit transaction monetary amount for a predicted deposit transaction (as the value-based deposit prediction data).

As previously mentioned, upon determining the deposit transaction prediction data, the digital deposit transaction modeling system can update a deposit transaction prediction data source with the deposit transaction prediction data to facilitate universal downstream access to the deposit transaction prediction data. In some cases, the digital deposit transaction modeling system enables downstream computer services (or applications) to provide (or transmit) data requests with instructions to retrieve various elements of the deposit transaction prediction data from the deposit transaction prediction data source in the data pipeline. Based on the data requests, the digital deposit transaction modeling system can provide elements for value-based and/or time-based deposit transaction data to the downstream services (and/or applications). To illustrate, the digital deposit transaction modeling system can enable downstream services (or applications), such as, but not limited to, deposit transaction applications, chatbot service applications, and/or payment scheduler applications to utilize the deposit transaction prediction data as part of the functionalities executed by the downstream services.

The digital deposit transaction modeling system can provide numerous technical advantages, benefits, and practical applications to relative conventional systems. To illustrate, unlike conventional systems that fail to flexibly transform deposit transaction data for downstream applications, the digital deposit transaction modeling system can transform deposit transaction data into robust data that enables various downstream services to accomplish various practical and insightful applications. For example, the digital deposit transaction modeling system can determine robust and insightful predictions for future deposit transactions from deposit transaction data of a user account. Furthermore, the digital deposit transaction modeling system can flexibly enable a wide variety of downstream applications to access and utilize the predicted deposit transactions to enable applications, such as, but not limited to, applications for modifying account values (or updating account values) using predicted (or anticipated) deposit transactions, applications for chatbot services that inform users of predicted deposit transactions, and/or applications for scheduling payments using predicted deposit transactions.

In addition, in contrast to conventional systems that lack data management and data modelling efficiency across large and numerous system networks, the digital deposit transaction modeling system efficiently enables multiple system networks to utilize predicted deposit transactions from an updating data source. Indeed, unlike systems that require local analysis of limited or partial data, the digital deposit transaction modeling system utilizes a deposit transaction predictor model within a data pipeline that utilizes data from various sources and updates a deposit transaction prediction data source that is accessible by various downstream computer network services or applications (e.g., via application programming interface (API) calls to the data pipeline for specific deposit transaction prediction data). Indeed, the digital deposit transaction modeling system can enable downstream services or applications to utilize predicted deposit transaction data with less local computation and reduced data transfers by enabling universal access to predicted deposit transaction data at an updating data source.

Moreover, by utilizing a data pipeline that accesses user account data from multiple data sources for a deposit transaction predictor model, the digital deposit modeling system utilizes a wider scope of data to determine accurate deposit transaction predictions. In particular, instead of relying on only locally available data like many conventional systems, the digital deposit modeling system can receive (or identify) data from multiple sources, that are usually disjointed, for a user account that may factor into a deposit transaction prediction within the deposit transaction predictor model. Accordingly, the digital deposit modeling system can determine deposit transaction predictions with improved accuracy for a user account. Indeed, in one or more embodiments, the digital deposit transaction modeling system 106 can enable a downstream service to request deposit transaction prediction data for a user account for specific deposit transaction sources by indicating a deposit transaction source. In some instances, the digital deposit transaction modeling system 106 can enable a downstream service to request deposit transaction prediction data for a user account for multiple deposit transaction sources (e.g., separate deposit transaction prediction data categorized by different deposit transaction sources).

Additionally, the digital deposit transaction modeling system can generate deposit transaction predictions that are updated in real time (or in near-real time). More specifically, the digital deposit modeling system can utilize updated user account data from various data sources with a deposit transaction predictor model to update deposit transaction predictions when new (or updated) data is identified in the data pipeline. By doing so, the digital deposit transaction modeling system can continuously (or frequently) update deposit transaction prediction data to provide up-to-date and accurate deposit transaction prediction data to one or more downstream computer network services (or applications) via the data pipeline.

As indicated by the foregoing discussion, the present disclosure utilizes a variety of terms to describe features and advantages of the data transformation system. As used herein the term “data pipeline” refers to a collection of services, tools, processes, and/or data sources that facilitate the movement and/or transformation of data between data sources and/or computer network services. As an example, a data pipeline can include various combinations of elements to receive or access data from a data source, transform and/or analyze the data, and/or store the data to a data repository. In some instances, the digital deposit modeling system can utilize data pipelines, such as, but not limited to, real-time data pipelines, batch pipelines, extract, transform, load (ETL) pipelines, big data pipelines, and/or extract, load, transform (ELT) pipelines.

As further used herein, the term “data source” refers to a service or repository (e.g., via hardware and/or software) that manages data (e.g., storage of data, access to data, collection of data). In some cases, a data source refers to a data service or data repository (e.g., via hardware and/or software) that manages data storage via cloud-based services and/or other networks (e.g., offline data stores, online data stores). To illustrate, a data source can include, but is not limited to, cloud computing-based data storage and/or local storage. In some cases, a data source can correspond to various cloud-based data service companies that facilitate the tracking, collection, storage, movement, and/or access to data. Furthermore, a data source can include a client device corresponding to a user account, a computer network corresponding to a deposit transaction source, and/or a user account transaction activity data repository.

As further used herein, the term “data request” (or sometimes referred to as “data source request”) refers to an instruction for a data source. In some cases, a data request can include instructions (or queries) to read from (and/or access) a data source (e.g., select data, export data) and/or write data to a data source (e.g., update data, delete data, insert into data, create database, create table, upload data). In some cases, the digital deposit transaction modeling system can receive data source requests as a set of instructions for a data pipeline represented in a programming paradigm (e.g., an application programming interface (API) or other declarative language).

Furthermore, as used herein, the term “deposit prediction data” (or sometimes referred to as “deposit transaction prediction”) refers to information indicating one or more future activities corresponding to deposit transactions on a user account. Indeed, in one or more embodiments deposit prediction data can include information that indicates future deposit transaction activities in a user account through predicted dates, predicted frequencies, predicted amounts, and/or an amount of a future deposit transaction that is already earned by a user account before a date of a predicted deposit transaction. For example, in one or more embodiments, the digital deposit transaction modeling system determines time-based deposit prediction data and/or value-based deposit prediction data as the deposit prediction data.

To illustrate, deposit prediction data can include time-based deposit prediction data that indicates a date for a future deposit transaction. Indeed, in one or more embodiments, time-based deposit prediction data indicates a predicted date at which a predicted (or anticipated) deposit transaction is likely to occur for a user account (e.g., a predicted direct deposit date and/or a predicted pay day within a user account). Moreover, in some cases, time-based deposit transaction data also indicates a predicted frequency at which predicted deposit transactions are likely to occur for a user account (e.g., direct deposits are likely to occur monthly, biweekly, weekly, daily).

Furthermore, deposit prediction data can include value-based deposit prediction data that indicates an amount corresponding to a future deposit transaction. For example, value-based deposit prediction data can indicate a monetary amount that will be deposited in a predicted (or anticipated) deposit transaction. Indeed, in some cases, the value-based deposit prediction data indicates a predicted pay amount for a direct deposit transaction (e.g., for pay from an employer or other source of income for the user account).

As used herein, the term “deposit transaction predictor model” refers to a model that determines (and/or outputs) deposit prediction data for a user account from user account data. For instance, a deposit transaction predictor model can include a mapping of information between various ranges or segments of user account data to various deposit transaction patterns (e.g., future deposit transaction dates, future deposit transaction amounts, future deposit transaction frequencies). Indeed, in one or more embodiments, a deposit transaction predictor model includes a rule-based model that determines patterns for future deposit transactions utilizing user account data, such as, but not limited to, historical user account deposit transactions. In some instances, a deposit transaction predictor model includes a machine learning model that determines (or outputs) predicted deposit transaction patterns for a user account from input user account data (e.g., historical user account deposit transactions, geo-locations, user account transaction history).

As used herein, the term “machine learning model” refers to a computer model that can be trained (e.g., tuned or learned) based on inputs to approximate unknown functions and corresponding outputs. As an example, a machine learning model can include, but is not limited to, a neural network (e.g., a convolutional neural network, recurrent neural network, or deep learning model), a decision tree (e.g., a gradient boosted decision tree, a random forest decision tree, a decision tree with variable or output probabilities), and/or a support vector machine.

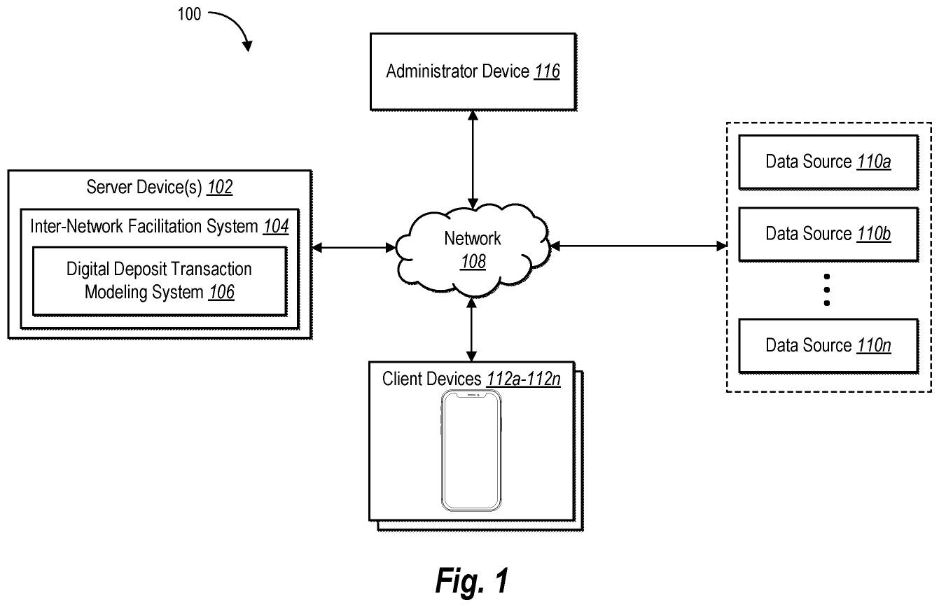

As used herein, the term “user account data” refers to information (or data) associated with interactions of a user within and/or in connection with an inter-network facilitation system (as described in FIG. 1). To illustrate, user account data can include, but is not limited to, historical utilization of an application, historical transaction activity within the user account (e.g., payments, setting changes, payment scheduling), historical deposit transactions, client device data (e.g., geo-location data, phone number data), historical withdrawal transactions, deposit transaction source information (e.g., employer information, change in employment information, account information for deposit transaction party, pay stub data), and/or user data (e.g., address, email address, employment, estimated income).

Furthermore, as used herein, the term “available deposit balance” refers to a numerical value that represents a transactional value available for utilization in a user account (e.g., via a deposit transaction) in connection to a predicted, future deposit transaction. For example, in one or more embodiments, an available deposit balance can include a numerical value that represents an amount that a user account is permitted to obtain or transact due to a predicted, future deposit transaction. To illustrate, an available deposit balance can include a monetary advance amount (e.g., an early deposit transaction amount or an early pay amount) calculated using a predicted, future deposit transaction for the user account.

Turning now to the figures, FIG. 1 illustrates a block diagram of a system 100 (or system environment) for implementing an inter-network facilitation system 104 and a digital deposit transaction modeling system 106 in accordance with one or more embodiments. As shown in FIG. 1, the system 100 includes server device(s) 102 (which includes the inter-network facilitation system 104 and the digital deposit transaction modeling system 106), client devices 112a-112n, an administrator device 116, and data sources 110a-110n. As further illustrated in FIG. 1, the server device(s) 102, the client devices 112a-112n, the administrator device 116, and the data sources 110a-110n can communicate via the network 108.

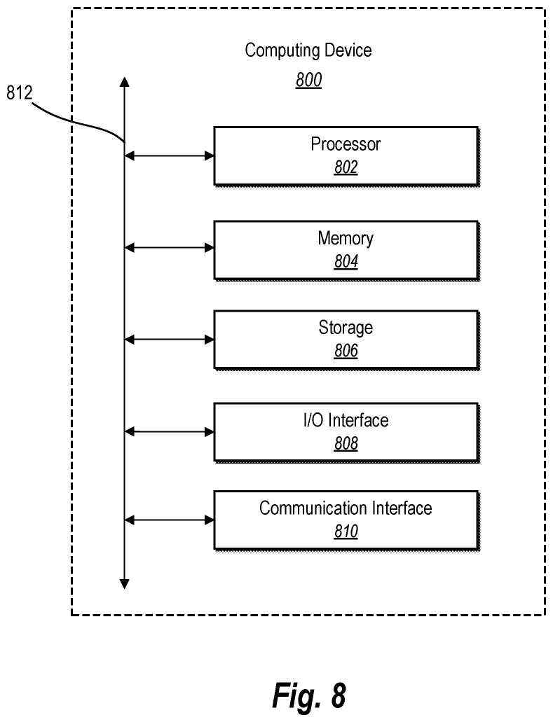

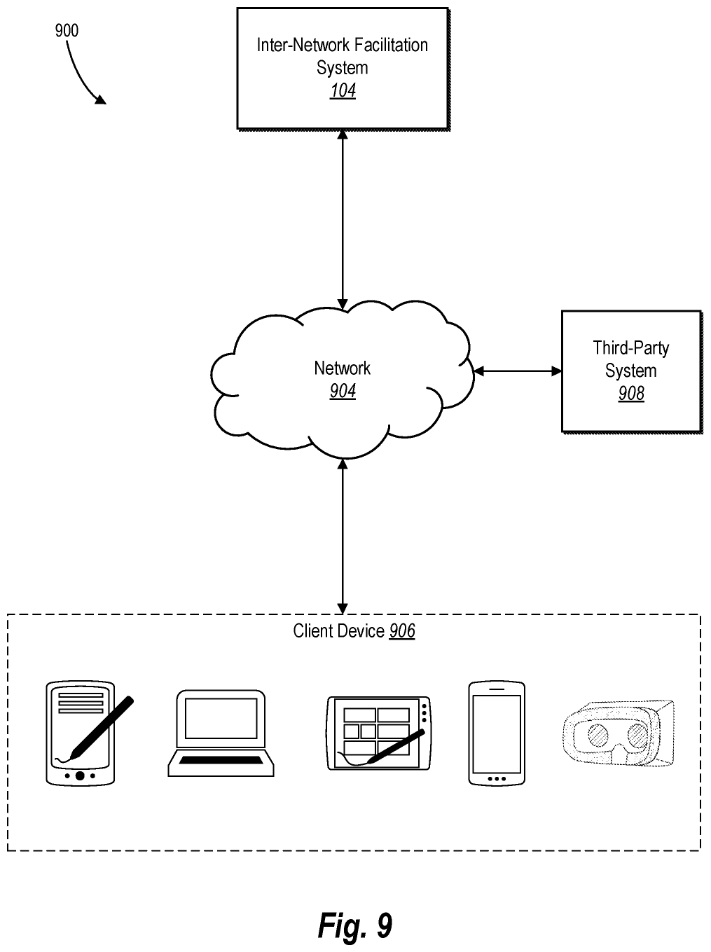

Although FIG. 1 illustrates the digital deposit transaction modeling system 106 being implemented by a particular component and/or device within the system 100, the digital deposit transaction modeling system can be implemented, in whole or in part, by other computing devices and/or components in the system 100 (e.g., the client devices 112a-112n). Additional description regarding the illustrated computing devices (e.g., the server device(s) 102, computing devices implementing the digital deposit transaction modeling system 106, the client devices 112a-112n, the administrator device 116, the network 108, and/or the data sources 110a-110n) is provided with respect to FIGS. 8 and 9 below.

As shown in FIG. 1, the server device(s) 102 can include the inter-network facilitation system 104. In some embodiments, the inter-network facilitation system 104 can determine, store, generate, and/or display financial information corresponding to a user account (e.g., a banking application, a money transfer application). Furthermore, the inter-network facilitation system 104 can also electronically communicate (or facilitate) financial transactions between one or more user accounts (and/or computing devices). Moreover, the inter-network facilitation system 104 can also track and/or monitor financial transactions and/or financial transaction behaviors of a user within a user account.

The inter-network facilitation system 104 can include a system that comprises the digital deposit transaction modeling system 106 and that facilitates financial transactions and digital communications across different computing systems over one or more networks. For example, the inter-network facilitation system 104 manages credit accounts, secured accounts, and other accounts for one or more accounts registered within the inter-network facilitation system 104. In some cases, the inter-network facilitation system 104 is a centralized network system that facilitates access to online banking accounts, credit accounts, and other accounts within a central network location. Indeed, the inter-network facilitation system 104 can link accounts from different network-based financial institutions to provide information regarding, and management tools for, the different accounts.

In one or more embodiments, the digital deposit transaction modeling system 106 utilizes a deposit transaction predictor model to determine deposit transaction prediction data for user accounts and enable universal access for the deposit transaction prediction data to downstream computer network services through a data pipeline. For instance, the digital deposit transaction modeling system 106 can receive user account data from the data sources 110a-110n for one or more user accounts corresponding to the client devices 112a-112n. Moreover, the digital deposit transaction modeling system 106 can utilize the user account data with a deposit transaction predictor model to determine various deposit transaction prediction data and, subsequently, update the data sources 110a-110n with the deposit transaction prediction data to enable universal access for the deposit transaction prediction data to downstream computer network services (in accordance with one or more implementations described herein).

Furthermore, as shown in FIG. 1, the system 100 includes the data sources 110a-110n. For example, the data sources 110a-110n can manage and/or store various data for the inter-network facilitation system 104, the client devices 112a-112n, and/or the administrator device 116. As mentioned above, the data sources 110a-110n can include various data services or data repositories (e.g., via hardware and/or software) that manage data storage via cloud-based services and/or other networks (e.g., offline data stores, online data stores). In some cases, the client devices 112a-112n can also operate as data sources within the data sources 110a-110n. Moreover, the data sources 110a-110n can include a data storage or computer network that corresponds to a deposit transaction source (e.g., an entity that is providing income to a user account). In one or more implementations, the data sources 110a-110n can include user account transaction activity data repositories for user accounts within the inter-network facilitation system 104.

As also illustrated in FIG. 1, the system 100 includes the client devices 112a-112n. For example, the client devices 112a-112n may include, but are not limited to, mobile devices (e.g., smartphones, tablets) or other type of computing devices, including those explained below with reference to FIGS. 8 and 9. Additionally, the client devices 112a-112n can include computing devices associated with (and/or operated by) user accounts for the inter-network facilitation system 104. Moreover, the system 100 can include various numbers of client devices that communicate and/or interact with the inter-network facilitation system 104 and/or the digital deposit transaction modeling system 106.

Furthermore, the client devices 112a-112n can include the client application(s). The client application(s) can include instructions that (upon execution) cause the client devices 112a-112n to perform various actions. For example, a user of a user account can interact with the client application(s) on the client devices 112a-112n to access financial information, initiate a financial transaction (e.g., transfer money to another account, deposit money, withdraw money), and/or access or provide data (to the data sources 110a-110n or the server device(s) 102).

In certain instances, the client devices 112a-112n corresponds to one or more user accounts (e.g., user accounts stored at the server device(s) 102). For instance, a user of a client device can establish a user account with login credentials and various information corresponding to the user. In addition, the user accounts can include a variety of information regarding financial information and/or financial transaction information for users (e.g., name, telephone number, address, bank account number, credit amount, debt amount, financial asset amount), payment information (e.g., account numbers), transaction history information (e.g., historical deposit transaction data), deposit transaction source information, client device data, and/or contacts for financial transactions. In some embodiments, a user account can be accessed via multiple devices (e.g., multiple client devices) when authorized and authenticated to access the user account within the multiple devices.

The present disclosure utilizes client devices to refer to devices associated with such user accounts. In referring to a client (or user) device, the disclosure and the claims are not limited to communications with a specific device, but any device corresponding to a user account of a particular user. Accordingly, in using the term client device, this disclosure can refer to any computing device corresponding to a user account of the inter-network facilitation system 104.

Additionally, as shown in FIG. 1, the system 100 also includes the administrator device 116. In certain instances, the administrator device 116 may include, but is not limited to, a mobile device (e.g., smartphone, tablet) or other type of computing device, including those explained below with reference to FIGS. 8 and 9. Additionally, the administrator device 116 can include a computing device associated with (and/or operated by) an administrator for the inter-network facilitation system 104. Moreover, the system 100 can include various numbers of administrator devices that communicate and/or interact with the inter-network facilitation system 104 and/or the digital deposit transaction modeling system 106. Indeed, the administrator device 116 can access data generated (or transformed) by one or more data pipelines running on the digital deposit transaction modeling system 106 and/or data of the data sources 110a-110n. Furthermore, the administrator device 116 can create, modify, receive, upload, provide, and/or configure various data pipeline jobs and/or configure various aspects or settings of the deposit transaction predictor model for the digital deposit transaction modeling system 106.

As further shown in FIG. 1, the system 100 includes the network 108. As mentioned above, the network 108 can enable communication between components of the system 100. In one or more embodiments, the network 108 may include a suitable network and may communicate using a various number of communication platforms and technologies suitable for transmitting data and/or communication signals, examples of which are described with reference to FIG. 9. Furthermore, although FIG. 1 illustrates the server device(s) 102, the client devices 112a-112n, the administrator device 116, and the data sources 110a-110n communicating via the network 108, the various components of the system 100 can communicate and/or interact via other methods (e.g., the server device(s) 102 and the client devices 112a-112n can communicate directly).

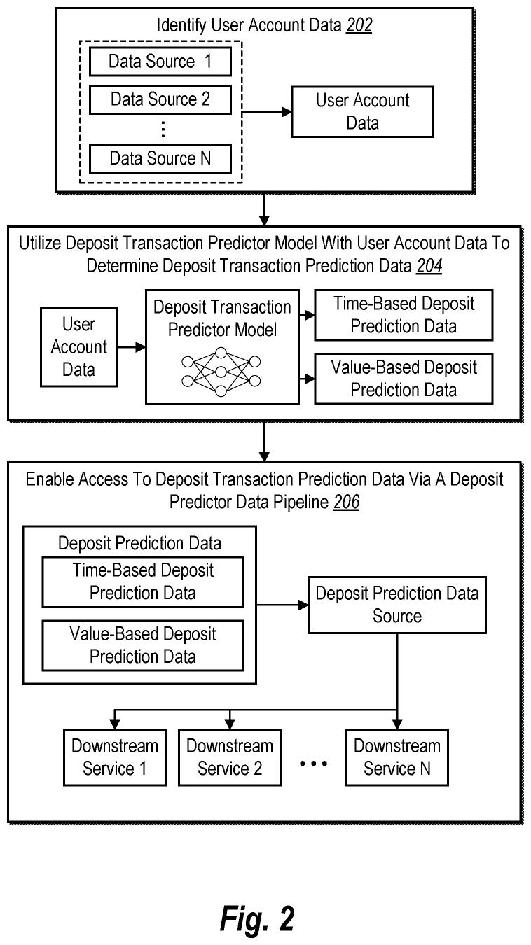

As mentioned above, the digital deposit transaction modeling system 106 utilizes a deposit transaction predictor model to determine deposit transaction prediction data for user accounts and enable universal access for the deposit transaction prediction data to downstream computer network services through a data pipeline. For example, FIG. 2 illustrates an overview of the digital deposit transaction modeling system 106 facilitating a data pipeline that determines deposit transaction prediction data with a deposit transaction predictor model and provides access to the deposit transaction prediction data. In particular, as shown in FIG. 2, the digital deposit transaction modeling system 106 identifies user account data from data sources, then utilizes the user account data with a deposit transaction predictor model to determine deposit prediction data, and enables access to the deposit transaction prediction data through a deposit predictor data pipeline.

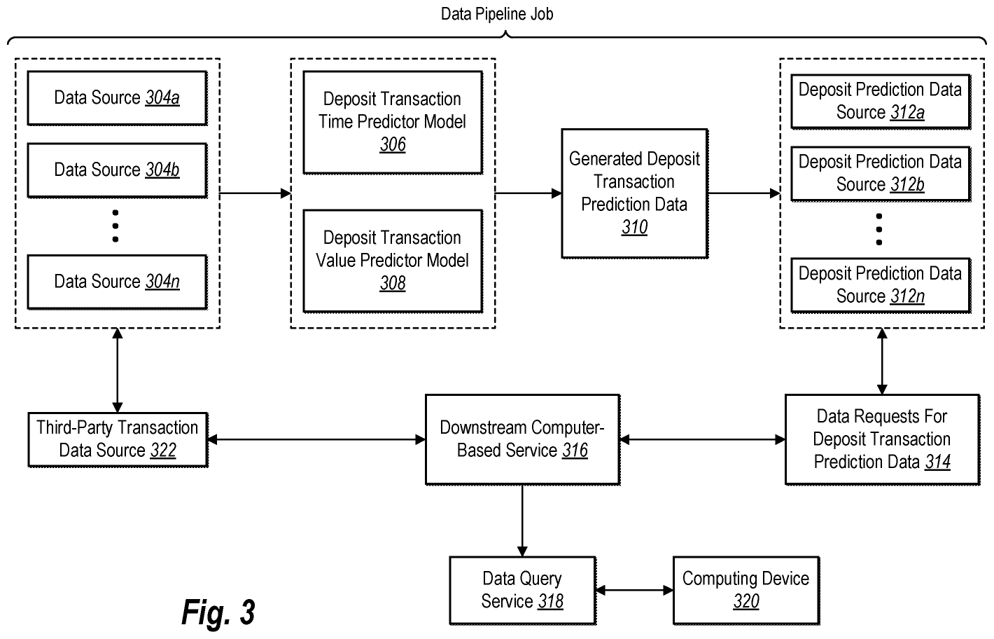

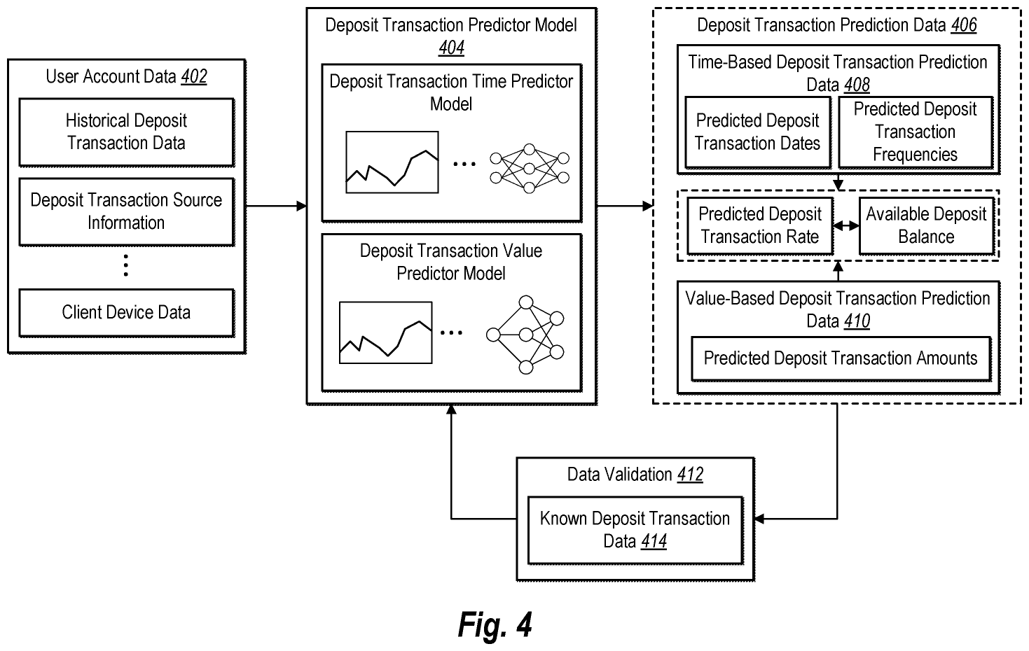

As shown in act 202 of FIG. 2, the digital deposit transaction modeling system 106 identifies user account data within a deposit predictor data pipeline. In particular, the digital deposit transaction modeling system 106 can identify user account data for user accounts from various data sources. In one or more implementations, the user account data can include, but is not limited to, historical deposit transaction data corresponding to user accounts, geo-location data from client devices corresponding to the user accounts, or deposit transaction source information corresponding to the user accounts. Furthermore, the digital deposit transaction modeling system 106 can access (or receive such user account data) from one or more data sources, such as, but not limited to, online and/or offline data storage services that track, collect, and/or store data for user accounts. Indeed, the digital deposit transaction modeling system 106 can identify user account data as described below (e.g., in relation to FIGS. 3 and 4).

Additionally, as shown in act 204 of FIG. 2, the digital deposit transaction modeling system 106 utilizes a deposit transaction predictor model with user account data to determine deposit transaction prediction data. In particular, as shown in the act 204 of FIG. 2, the digital deposit transaction modeling system 106 can utilize user account with a deposit transaction predictor model to output deposit transaction prediction data. For instance, the output deposit transaction prediction data can include, but not limited to, time-based deposit prediction data and value-based deposit prediction data. Indeed, the digital deposit transaction modeling system 106 utilizing a deposit transaction predictor model to determine (or output) deposit transaction prediction data is described below (e.g., in FIG. 4).

Moreover, as shown in act 206 of FIG. 2, the digital deposit transaction modeling system 106 enables access to deposit transaction prediction data via a deposit predictor data pipeline. In particular, as shown in the act 206, upon determining the deposit transaction prediction data (e.g., in the act 204), the digital deposit transaction modeling system 106 updates a deposit prediction data source that transmits (upon receiving a data request) deposit transaction prediction data to one or more downstream services (or applications). Indeed, the digital deposit transaction modeling system 106 enabling universal access to deposit transaction prediction data for various applications is described below (e.g., in FIG. 3-5).

As mentioned above, the digital deposit transaction modeling system 106 utilizes a deposit predictor data pipeline to enable universal access to deposit transaction prediction data.

To illustrate, FIG. 3 illustrates an exemplary environment in which the digital deposit transaction modeling system 106 utilizes a deposit predictor data pipeline job. For example, as shown in FIG. 3, the digital deposit transaction modeling system 106 receives user account data from one or more of data sources 304a-304n and utilizes the user account data with deposit transaction prediction models to generate deposit transaction prediction data. Indeed, as shown in FIG. 3, the digital deposit transaction modeling system 106 utilizes data from the data sources 304a-304n with a deposit transaction date predictor model 306 and a deposit transaction value prediction model 308 to determine the generated deposit transaction prediction data 310.

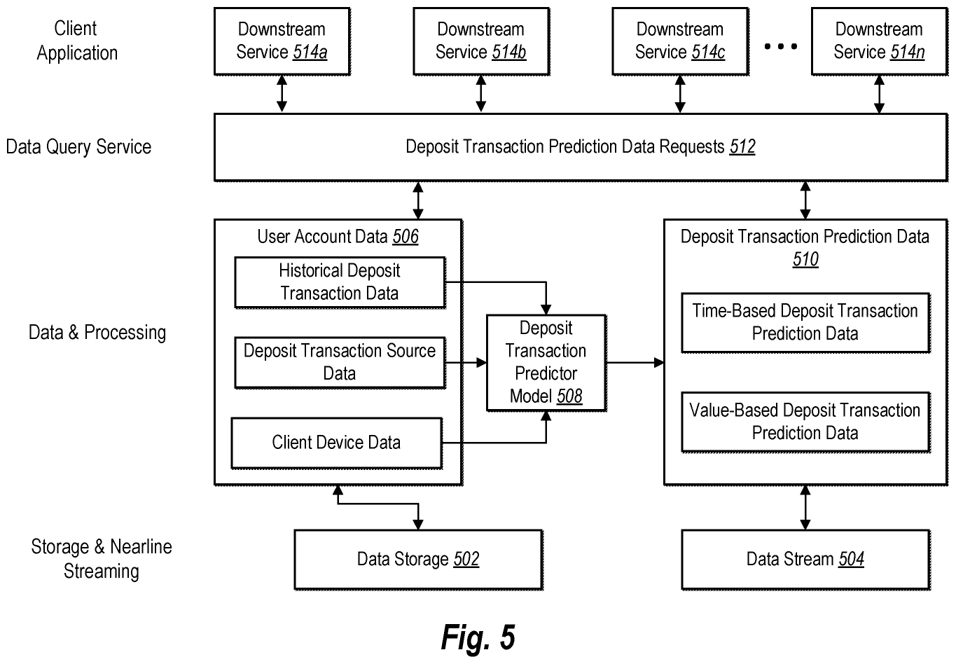

Furthermore, as shown in FIG. 3, the digital deposit transaction modeling system 106 updates one or more of deposit prediction data sources 312a-312n with the generated deposit transaction prediction data 310. Indeed, as further shown in FIG. 3, the digital deposit transaction modeling system 106 facilitates access to deposit transaction prediction data at downstream services utilizing the updated deposit prediction data sources 312a-312n. In particular, as shown in FIG. 3, the digital deposit transaction modeling system 106 enables a downstream computer-based service 316 to utilize a data query service 318 to transmit data requests 314 for deposit transaction prediction data to the deposit prediction data sources 312a-312n. Upon receiving the data requests 314, the digital deposit transaction modeling system 106 causes the deposit prediction data sources 312a-312n to provide one or more elements for value-based and/or time-based deposit transaction data to the downstream computer-based service 316. In addition, in one or more embodiments, the downstream computer-based service 316 can utilize the received one or more elements for the value-based and/or time-based deposit transaction data to create and/or enable one or more functionalities for a computing device 320 (e.g., a client device corresponding to a user account) as described below (e.g., in relation to FIG. 5).

In one or more embodiments, the digital deposit transaction modeling system 106 utilizes the deposit transaction predictor data pipeline to enable universal access to predicted deposit transaction data for multiple user accounts in real (or near-real) time. In particular, in reference to FIG. 3, the digital deposit transaction modeling system 106 iteratively (or continuously) receives (or requests) user account data (e.g., as part of a data pipeline job schedule individually or as a batch of user account data) from the one or more data sources 304a-304n (e.g., updated user account data). Moreover, the digital deposit transaction modeling system 106 utilizes the updated user account data with the deposit transaction date predictor model 306 and the deposit transaction value prediction model 308 to generate updated deposit transaction prediction data for the one or more user accounts. Subsequently, the digital deposit transaction modeling system 106 updates (e.g., via publishing or stream) the one or more deposit prediction data sources 312a-312n with the updated deposit transaction prediction data. Accordingly, in reference to FIG. 3, the downstream computer-based service 316 can receive updated deposit transaction prediction data (in real or near-real time) from the continuously updating one or more deposit prediction data sources 312a-312n.

As previously mentioned, the data sources 304a-304n can include a service or repository that manages data via cloud-based services and/or other networks (e.g., offline data stores, online data stores). In one or more embodiments, the data sources 304a-304n can manage data (e.g., storage of data, access to data, collection of data) for the inter-network facilitation system 104. In particular, the data sources 304a-304n can include data for user accounts, such as, but not limited to, user account information (e.g., user attributes, settings, information), transaction activities, application activities, and/or historical deposit transaction data. In addition, the data sources 304a-304n can include data from various systems of the inter-network facilitation system 104 and/or other systems (e.g., third-party systems, payroll computer systems, various third-party computer systems corresponding to employers for users of the user accounts, network transaction platforms).

As further shown in FIG. 3, the digital deposit transaction modeling system 106, in some instances, utilizes third-party transaction data source 322. In some cases, the third-party transaction data source 322 can include a data source that collects, manages, and/or transforms transactional data between one or more financial transaction systems. In particular, in some cases, the third-party transaction data source 322 can include a financial transaction system that manages and/or provides wage payment data (or other deposit transaction data) for a user corresponding to a user account of a user of the inter-network facilitation system 104. In some cases, the digital deposit transaction modeling system 106 utilizes the wage payment and/or other deposit transaction data (as ground truth data) from the third-party transaction data source 322 to validate and/or train deposit transaction prediction models as described below (e.g., in relation to FIG. 5).

As mentioned above, the digital deposit transaction modeling system 106 can utilize a deposit transaction predictor model to generate deposit transaction prediction data for user accounts of the inter-network facilitation system 104. For example, FIG. 4 illustrates the digital deposit transaction modeling system 106 utilizing a deposit transaction predictor model. In particular, FIG. 4 illustrates the digital deposit transaction modeling system 106 utilizing various types of user account data with a deposit transaction predictor model to output (or generate) deposit transaction prediction data (e.g., time-based and/or value-based deposit transaction prediction data).

As shown in FIG. 4, the digital deposit transaction modeling system 106 provides user account data 402 to a deposit transaction predictor model 404. Indeed, as illustrated in FIG. 4, the user account data 402 can include, but is not limited to, historical deposit transaction data, deposit transaction source information, and client device data. As further shown in FIG. 4, the digital deposit transaction modeling system 106 utilizes the user account data 402 with the deposit transaction predictor model 404 (which includes deposit transaction time predictor model and a deposit transaction value predictor model) to output (or generate) various deposit transaction prediction data 406.

In one or more embodiments, as shown in FIG. 4, the digital deposit transaction modeling system 106 utilizes historical deposit transaction data from the user account data 402 for the deposit transaction predictor model 404. In one or more embodiments, the digital deposit transaction modeling system 106 identifies historical deposit transaction data that indicate deposit transaction dates and/or amounts for deposit transactions that have occurred in the past for one or more user accounts. Indeed, the historical deposit transaction data can include known deposit transactions that indicate a monetary amount added (or deposited) into an account value of a user account. In one or more embodiments, the digital deposit transaction modeling system 106 identifies a variety of historical deposit transactions for user accounts originating from transactions, such as, but not limited to, user deposited checks or electronic checks, peer-to-peer money transfers, refunds from various merchants or government agencies (e.g., a tax agency), user deposited checks from one or more employers (or businesses) of user of the user accounts, and/or direct deposit transactions from one or more employers (or businesses) of user of the user accounts. In some cases, the digital deposit transaction modeling system 106 identifies and utilizes the historical transactions from user deposited checks from one or more employers (or businesses) of user of the user accounts and/or direct deposit transactions from one or more employers (or businesses) of user of the user accounts for the deposit transaction predictor model.

In some instances, as shown in FIG. 4, the digital deposit transaction modeling system 106 utilizes deposit transaction source information from the user account data 402 for the deposit transaction predictor model 404. For example, the digital deposit transaction modeling system 106 can identify deposit transaction source information for user accounts, such as, but not limited to, employer information (e.g., entity names, addresses, or contact information of employers) and/or self-employed business information (e.g., business names, addresses, or contact information of businesses operated and/or a source of income for users of the user accounts). In some cases, the digital deposit transaction modeling system 106 can identify employer and/or business contact information for employment and/or ownership verification (e.g., verification emails and/or calls) of the employers and/or businesses (that are income sources for users of the user accounts). Indeed, the digital deposit transaction modeling system 106 utilizes the deposit transaction source information to identify historical deposit transactions for the deposit transaction predictor model and/or as parameters in the deposit transaction predictor model to determine deposit transaction prediction data.

In some implementations, as shown in FIG. 4, the digital deposit transaction modeling system 106 utilizes client device data from the user account data 402 for the deposit transaction predictor model 404. In some cases, the digital deposit transaction modeling system 106 can utilize client device data, such as, but not limited to geo-locations of client devices corresponding to user accounts (e.g., via GPS, Wi-Fi, Bluetooth) and/or user activity times on various applications (or software) on client devices corresponding to user accounts. For example, in some instances, the digital deposit transaction modeling system 106 utilizes geolocations of client devices with a deposit transaction predictor model to determine hours of employment (e.g., a number of hours users spend at places of employment) for the deposit transaction prediction data. In some cases, the digital deposit transaction modeling system 106 utilizes user activity times on various applications or software (e.g., software and/or tools utilized by employers or businesses) while the applications or software are operated on client devices corresponding to the user accounts with a deposit transaction predictor model to determine hours of employment for the deposit transaction prediction data.

Although one or more embodiments illustrate the digital deposit transaction modeling system 106 utilizing historical deposit transaction data, deposit transaction source information, and client device data for deposit transaction predictor models, the digital deposit transaction modeling system 106 can utilize various other user account data. For example, the digital deposit transaction modeling system 106 can utilize user data, such as, but not limited, user residence information, user employment information, and/or user provided income data. In some cases, the digital deposit transaction modeling system 106 can utilize user account data, such as, but not limited to, user entered work hours for one or more employers and/or businesses corresponding to the user accounts.

Furthermore, as shown in FIG. 4, the digital deposit transaction modeling system 106 can utilize the deposit transaction time predictor model from the deposit transaction predictor model 404 to generate (or determine) time-based deposit transaction prediction data 408 (using the user account data 402). As shown in FIG. 4, the time-based deposit transaction prediction data 408 includes predicted deposit transaction dates determined by the deposit transaction time predictor model using the user account data 402 that indicate predicted dates at which predicted deposit transactions will occur for various user accounts. Furthermore, as shown in FIG. 4, the time-based deposit transaction prediction data 408 includes predicted deposit transaction frequencies determined by the deposit transaction time predictor model using the user account data 402 that indicate predicted frequencies at which predicted deposit transactions will occur for various user accounts.

In some embodiments, the digital deposit transaction modeling system 106 determines, via the deposit transaction time predictor model, one or more predicted dates for future deposit transactions in user accounts. For example, a predicted deposit transaction date can indicate a day or time of a predicted deposit transaction and/or a predicted date range for the future deposit transactions (e.g., within a range of days or a range of time). In some embodiments, the digital deposit transaction modeling system 106 can determine, via the deposit transaction time predictor model, multiple predicted dates for multiple future deposit transactions in a user account (e.g., a determined or predicted schedule of predicted deposit transactions). Furthermore, in some cases, the digital deposit transaction modeling system 106, via the deposit transaction time predictor model, can determine a predicted deposit transaction frequency that indicates a predicted pattern for the predicted deposit transactions (e.g., a bi-weekly deposit, a semi-monthly deposit, a daily deposit). In one or more implementations, the digital deposit transaction modeling system 106 can utilize the predicted deposit transaction frequency to determine a predicted shift for a user of a user account corresponding to the deposit transaction prediction data.

Moreover, as shown in FIG. 4, the digital deposit transaction modeling system 106 can utilize the deposit transaction value predictor model to generate (or determine) value-based deposit transaction prediction data 410 (using the user account data 402). As shown in FIG. 4, the value-based deposit transaction prediction data 410 includes predicted deposit transaction amounts determined by the deposit transaction value predictor model using the user account data 402. Indeed, in one or more embodiments, the predicted deposit transaction amounts can indicate predicted monetary amounts that may be deposited in user accounts for predicted deposit transactions.

In one or more embodiments, the digital deposit transaction modeling system 106 determines, via the deposit transaction value predictor model, one or more deposit transaction amount predictions for predicted deposit transactions as the value-based deposit transaction prediction data. For instance, a deposit transaction amount prediction can indicate a monetary amount (or account value) that may be deposited into a user account during a predicted deposit transaction. In some cases, the digital deposit transaction modeling system 106 determines, via the deposit transaction value predictor model, multiple deposit transaction amount predictions for multiple deposit transaction predictions on different predicted deposit transaction dates. Moreover, in some cases, the digital deposit transaction modeling system 106 utilizes the deposit transaction value predictor model to determine predicted amount ranges for the future deposit transactions (e.g., a range of a monetary amount predicted to occur during a predicted deposit transaction).

In some instances, as shown in FIG. 4, the digital deposit transaction modeling system 106 also utilizes the deposit transaction predictor model to determine a predicted deposit transaction rate. For example, the digital deposit transaction modeling system 106 can utilize a combination of predicted deposit transaction dates, predicted deposit transaction frequencies, and/or predicted deposit transaction amounts to determine a predicted deposit transaction rate for a user account. In particular, in one or more embodiments, the digital deposit transaction modeling system 106 can determine a predicted deposit transaction rate that indicates a monetary amount that a user is predicted to receive within a specific time frame (e.g., per hour, per day, per month). Indeed, the digital deposit transaction modeling system 106 can utilize a predicted deposit transaction frequency deposit with one or more predicted deposit transaction amounts to determine a predicted deposit transaction rate.

Furthermore, in one or more embodiments, the digital deposit transaction modeling system 106 can determine available deposit balances for user accounts utilizing the deposit transaction prediction data. In particular, the digital deposit transaction modeling system 106 can determine an available deposit balance for a user account that indicates or represents a deposit amount that the user account can access via a deposit transaction (e.g., at a time earlier than a predicted deposit transaction date). For instance, the digital deposit transaction modeling system 106 can utilize the predicted deposit transaction amount as the available deposit balance. Indeed, upon receiving a request to utilize the available deposit balance at a downstream computer-based system, the digital deposit transaction modeling system 106 can enable the downstream computer-based system to modify a user account value based on the available deposit balance. For example, the digital deposit transaction modeling system 106 can cause the downstream computer-based system to modify a user account value of a user account to include the available deposit balance based on anticipation of the predicted deposit transaction at a future date (e.g., as an early pay or advance of the predicted deposit transaction).

In some implementations, the digital deposit transaction modeling system 106 determines an available deposit balance for a user account (as the value-based deposit prediction data) by using a predicted deposit transaction rate for the user account with a historical transaction date from the user account. In particular, the digital deposit transaction modeling system 106 determines the most previous deposit transaction date occurring on the user account (e.g., for a direct deposit corresponding to an employer or business income payment). Then, the digital deposit transaction modeling system 106 utilizes the predicted deposit transaction rate with the most previous deposit transaction date to determine an available deposit balance for the user account corresponding to the amount of time that has been covered between the most previous deposit transaction date and a subsequent predicted deposit transaction date.

As an example, the digital deposit transaction modeling system 106 can determine that a previous deposit transaction occurred on October 1^{st} and that the subsequent predicted deposit transaction date is on October 10^{th}. As part of the above-mentioned example, the digital deposit transaction modeling system 106 can, on October 5^{th}, determine that 5 days (e.g., earned time) have passed between the previous deposit transaction and the subsequent predicted deposit transaction date. Accordingly, the digital deposit transaction modeling system 106 can utilize the earned time (e.g., 5 days) with the predicted deposit transaction rate to determine an available deposit balance. To further the example above, if the predicted deposit transaction rate is determined to be $10 a day, the digital deposit transaction modeling system 106 can determine that the user account has an available deposit balance of $50 using the earned time (e.g., 5 days) between the most previous deposit transaction date and a subsequent predicted deposit transaction date.

In one or more implementations, the digital deposit transaction modeling system 106 utilizes a heuristic (rule) based model for the deposit transaction time predictor model to predict (or determine) deposit transaction patterns (for the time-based deposit transaction prediction data). For example, the digital deposit transaction modeling system 106 identifies and leverages patterns (e.g., date patterns) determined from historical deposit transaction dates, gaps between historical deposit transactions, deposit transaction source, and/or other user account data to determine a predicted deposit transaction date. In particular, the digital deposit transaction modeling system 106 can utilize a deposit transaction time predictor model that maps or associates various historical deposit transaction dates, gaps between historical deposit transactions, deposit transaction source, and/or other user data to particular patterns (e.g., a repeating occurrence). In some cases, the deposit transaction time predictor model utilizes the historical deposit transaction dates, gaps between historical deposit transactions, deposit transaction source, and/or other user account data to project future dates for future deposit transactions (e.g., using a regression analysis or other forecasting tool). In some instances, the deposit transaction time predictor model leverages various statistical models to determine a particular date pattern from the historical deposit transaction dates, gaps between historical deposit transactions, deposit transaction source, and/or other user account data, such as, but not limited to a median time between deposit transactions, a mean time between deposit transactions, a mode time between deposit transactions, and/or other aggregated statistics for time between deposit transactions.

In one or more embodiments, the digital deposit transaction modeling system 106 utilizes various parameters for the deposit transaction time predictor model. In particular, the digital deposit transaction modeling system 106 can utilize and/or modify various parameters, such as, but not limited to prediction time windows, time windows for historical deposit transactions, number of historical deposit transactions, and/or utilized data. For example, the digital deposit transaction modeling system 106 can adjust a prediction time window by selecting or setting a range of accuracy (e.g., an error tolerance range) for a predicted deposit transaction date (e.g., a predicted date with a range of plus or minus 1 day, plus or minus 3 days, plus or minus 5 days). In some cases, the digital deposit transaction modeling system 106 can adjust a time window for historical deposit transaction (e.g., using the last two months, three months, one month of historical deposit transaction data) and/or a number of historical deposit transaction (e.g., using the last four, five, six historical deposit transaction data). In some cases, the digital deposit transaction modeling system 106 can determine to utilize or exclude various user account data in the deposit transaction time predictor model (e.g., excluding geo-location data or deposit transaction source information).

Moreover, in one or more embodiments, the digital deposit transaction modeling system 106 utilizes the deposit transaction time predictor model to categorize predicted deposit transaction dates (or pattern) as a predicted deposit transaction frequency. For instance, the digital deposit transaction modeling system 106 can determine a pattern or trend at which historical deposit transaction dates occur and/or a pattern or trend at which predicted deposit transaction dates occur. For example, the pattern or trend can represent a deposit transaction occurrence rate (e.g., every 2 weeks, every 30 days, every 15 days). Then, the digital deposit transaction modeling system 106 can classify the determined pattern or trend within a particular predicted deposit transaction frequency category (e.g., bi-weekly, monthly, semi-monthly).

Additionally, in one or more embodiments, the digital deposit transaction modeling system 106 utilizes a heuristic (rule) based model for the deposit transaction value predictor model to predict (or determine) deposit transaction patterns (for value-based deposit transaction prediction data). For instance, the digital deposit transaction modeling system 106 identifies and leverages patterns (e.g., amount patterns) determined from historical deposit transaction amounts of historical deposit transactions and other user account data to determine a predicted deposit transaction amount. For instance, in some cases, the digital deposit transaction modeling system 106 utilizes historical deposit transaction amounts of historical deposit transactions and other user account data with the deposit transaction value predictor model to determine averaged predicted deposit transaction amount. Moreover, in one or more embodiments, the digital deposit transaction modeling system 106 utilizes a weighted average of the historical deposit transaction amounts of historical deposit transactions as a predicted deposit transaction amount. Although one or more embodiments describe the digital deposit transaction modeling system 106 utilizing a deposit transaction value predictor model to determine averages for historical deposit transaction amounts of historical deposit transactions, the digital deposit transaction modeling system 106 can utilize various statistical approaches, such as, but not limited to, medians, modes, minimums, maximums of the historical deposit transaction amounts of historical deposit transactions.

In some cases, the digital deposit transaction modeling system 106 utilizes the historical deposit transaction amounts of historical deposit transactions and other user account data with the deposit transaction value predictor model to determine forecasted predicted deposit transaction amounts. For instance, the digital deposit transaction modeling system 106 can utilize historical deposit transaction amounts to determine a trend or projection for the historical deposit transaction amounts and utilize the projection to determine a forecasted deposit transaction amount as the predicted deposit transaction amount. For instance, the digital deposit transaction modeling system 106 can determine forecasted predicted deposit transaction amounts by utilizing a deposit transaction value predictor model that utilizes regression analysis and/or other statistic forecasting tools.

Furthermore, in some embodiments, the digital deposit transaction modeling system 106 utilizes various parameters (or rules) for the deposit transaction value predictor model. For example, the digital deposit transaction modeling system 106 can utilize and/or modify various parameters, such as, but not limited to prediction amount ranges, time windows for historical deposit transactions, number of historical deposit transactions, and/or utilized data. For example, the digital deposit transaction modeling system 106 can adjust a prediction amount range by selecting or setting a range (e.g., an error tolerance range) for a predicted deposit transaction amount (e.g., a predicted amount with a range of plus or minus $100, plus or minus $50, plus or minus $200). In some cases, the digital deposit transaction modeling system 106 can adjust a time window (e.g., as a rule) for historical deposit transaction, a number of historical deposit transaction, and/or utilize or exclude various user account data as described above.

In some cases, the digital deposit transaction modeling system 106 can utilize weights for the historical deposit transactions as modifiable parameters for the deposit transaction value predictor model. For example, in one or more embodiments, the digital deposit transaction modeling system 106 can assign weights to various historical deposit transactions based on various characteristics of the historical deposit transactions (e.g., age of the transaction, frequency of similar transactions, consistency of similar transactions). Then, the digital deposit transaction modeling system 106 can utilize the weights to determine weighted averages (or other forecasts) for the historical deposit transaction amounts with the deposit transaction value predictor model to generate weight averaged (or other forecasted) deposit transaction amount predictions.

Furthermore, in one or more embodiments, the digital deposit transaction modeling system 106 utilizes outlier detection logic as part of the deposit transaction value predictor model. For example, the digital deposit transaction modeling system 106 determines or generates outlier detection logic as a modifiable parameter that controls or indicates historical deposit transaction amounts that will be excluded from consideration or analysis within the deposit transaction value predictor model. To illustrate, the digital deposit transaction modeling system 106 can utilize outlier detection logic that identifies historical transaction deposit values that satisfy one or more threshold amount ranges. In particular, the digital deposit transaction modeling system 106 can utilize outlier detection logic that excludes historical transaction deposit values that are greater than (or equal to) a maximum outlier value (e.g., a deposit transaction amount determined as substantially or abnormally high for a user account or user accounts) or less than (or equal to) a minimum outlier value (e.g., a deposit transaction amount determined as substantially or abnormally low for a user account or user accounts). In some cases, the digital deposit transaction modeling system 106 can modify or adjust parameters of the outlier detection logic by adjusting or modifying the threshold amount ranges (e.g., maximum and/or minimum outlier values).

In some instances, the digital deposit transaction modeling system 106 can utilize outlier detection logic to identify historical deposit transaction types that will be excluded from consideration or analysis within the deposit transaction value predictor model. For instance, the digital deposit transaction modeling system 106 can identify that a historical deposit transaction does not correspond to a routine or reoccurring paycheck or income category (e.g., reimbursements, tax refunds, peer-to-peer payment, refunds). Moreover, upon identifying that a historical deposit transaction does not correspond to a routine or reoccurring paycheck or income category, the digital deposit transaction modeling system 106 can exclude the identified historical deposit transaction from consideration or analysis within the deposit transaction value predictor model.

In some embodiments, the digital deposit transaction modeling system 106 utilizes a machine learning based deposit transaction predictor model to determine deposit transaction prediction data. For instance, in one or more embodiments, the digital deposit transaction modeling system 106 inputs user account data into the machine learning deposit transaction predictor model. Moreover, the machine learning deposit transaction predictor model analyzes the user account data to generate deposit transaction prediction data as an output. In some cases, the digital deposit transaction modeling system 106 can utilize the machine learning deposit transaction predictor model to determine various deposit transaction prediction data, such as, the predicted deposit transaction dates, predicted deposit transaction frequencies, predicted deposit transaction amounts, predicted deposit transaction rate, available deposit balances, and/or confidence scores for the predicted data.

Although one or more embodiments illustrate the digital deposit transaction modeling system 106 utilizing a deposit transaction time predictor model and a deposit transaction value predictor model as the deposit transaction predictor model, the digital deposit transaction modeling system 106 can utilize a singular deposit transaction predictor model to determine both time-based deposit transaction prediction data and value-based deposit transaction prediction data.

As previously mentioned, in one or more embodiments, the digital deposit transaction modeling system 106 can utilize known deposit transaction data to validate or train a deposit transaction predictor model. For example, as shown in act 412 of FIG. 4, the digital deposit transaction modeling system 106 utilizes known deposit transaction data 414 to run data validation of the deposit transaction prediction data 406. In particular, in the act 412, the digital deposit transaction modeling system 106 utilizes known deposit transaction data 414 (e.g., from a third-party transaction data source or various other data sources as described in FIG. 3) to validate the deposit transaction prediction data 406. For instance, the known deposit transaction data 414 can include known deposit transaction dates, amounts, available deposit balances, and/or frequencies.

In some cases, to validate a deposit transaction predictor model, the digital deposit transaction modeling system 106 determines whether a deposit transaction prediction is correct or incorrect. For example, the digital deposit transaction modeling system 106 can compare a predicted deposit transaction date to a known deposit transaction date to label the predicted deposit transaction date as correct when the predicted date matches a known date or label the predicted deposit transaction date as incorrect when the predicted date does not match the known date. In some cases, the digital deposit transaction modeling system 106 can label the predicted deposit transaction date as correct if the predicted date is within a range of the known date (e.g., plus or minus 2 days, plus or minus 1 day).

Furthermore, the digital deposit transaction modeling system 106 can determine whether a predicted deposit transaction amount is correct or incorrect by comparing the predicted deposit transaction amount to a known deposit transaction amount. For instance, the digital deposit transaction modeling system 106 can determine that a predicted deposit transaction amount is correct if the predicted deposit transaction amount matches a known deposit transaction amount or is incorrect when the predicted deposit transaction amount does not match the known deposit transaction amount. In some implementations, the digital deposit transaction modeling system 106 can label the predicted deposit transaction amount as correct when the predicted amount is within a range of the known amount (e.g., plus or minus $100, plus or minus $200). In some cases, the digital deposit transaction modeling system 106 determines that a predicted deposit transaction amount is correct when both the predicted deposit transaction amount and the known deposit transaction amount are greater than or less than (or equal to) a preselected (or preset) eligible deposit balance amount (e.g., a selected limit for an amount that will be available to a user as an available deposit balance).

Indeed, in some cases, the digital deposit transaction modeling system 106 utilizes the known deposit transaction data 414 to modify or adjust parameters of the deposit transaction predictor model 404 to improve the accuracy of the model (e.g., the deposit transaction date predictor model and/or the deposit transaction value predictor model). For example, the digital deposit transaction modeling system 106 can utilize the known deposit transaction data 414 with deposit transaction prediction data 406 (e.g., time-based deposit transaction prediction data 408, value-based deposit transaction prediction data 410) to determine an accuracy (or error rate) of the deposit transaction prediction data 406. For instance, the digital deposit transaction modeling system 106 can adjust or modify or adjust prediction time windows, prediction value ranges, time windows for historical deposit transactions, number of historical deposit transactions, and/or utilized data to determine whether subsequent deposit transaction prediction data improves in accuracy.

In one or more embodiments, the digital deposit transaction modeling system 106 utilizes a subsequent deposit transaction in a user account as part of known deposit transaction data 414. For instance, upon determining predicted deposit transactions for various user accounts, the digital deposit transaction modeling system 106 subsequently collects data for the next deposit transactions on the various user accounts (e.g., as part of the deposit transaction prediction data pipeline). Then, the digital deposit transaction modeling system 106 compares the subsequently collected deposit transaction data (as known deposit transaction data) to the predicted deposit transactions to determine an accuracy (or error rate) to modify or adjust parameters of the deposit transaction predictor model 404 to improve the accuracy of the model.

In some implementations, the digital deposit transaction modeling system 106 can utilize data validation (as described above) to determine a confidence score (or flag) for a user account. For example, the digital deposit transaction modeling system 106 can utilize the data validation approach described above to determine an accuracy of deposit transaction prediction data for a user and utilize the accuracy to assign a confidence score (or flag) to the user account (e.g., to indicate an accuracy of predicted deposit transaction data from the deposit transaction predictor model for the user account). In one or more embodiments, the digital deposit transaction modeling system 106 can provide to or update the deposit prediction data sources (as described in FIG. 3) with the confidence scores (or flags) for one or more user accounts to represent the accuracy of the predicted deposit transaction data for the one or more user accounts. Indeed, in one or more embodiments, the digital deposit transaction modeling system 106 can utilize confidence scores for both value-based and time-based predicted deposit transaction data and/or separate confidence scores for the value-based and time-based predicted deposit transaction data of user accounts.

Moreover, the digital deposit transaction modeling system 106 can utilize confidence scores to determine a confidence group for a user account. For instance, the digital deposit transaction modeling system 106 can utilize various confidence groups to indicate various levels (or amounts) of confidence (e.g., high confidence, low confidence, average confidence). For instance, the digital deposit transaction modeling system 106 can utilize determine confidence scores and confidence score ranges corresponding to different confidence groups to assign a confidence group to a user account (e.g., for deposit transaction predictions generally, for time-based deposit transaction predictions, and/or for value-based deposit transaction predictions).

In some instances, the digital deposit transaction modeling system 106 can determine a confidence score utilizing accuracy ranges. Indeed, the digital deposit transaction modeling system 106 can utilize known deposit transaction data to determine error percentages for the confidence scores. To illustrate, the digital deposit transaction modeling system 106 can determine an error percentage between predicted transaction dates for a user account compared to known deposit transaction dates for the user account (e.g., within a selected accuracy criterion, such as plus or minus 1 day, plus or minus 2 days). In some cases, the digital deposit transaction modeling system 106 can determine an error percentage between predicted transaction amounts for a user account compared to known transaction amounts for the user account (e.g., within a selected accuracy criterion, such as plus or minus 15 percent of the known amount, plus or minus 30 percent of the known amount). Furthermore, in one or more embodiments, the digital deposit transaction modeling system determines an error percentage utilizing various approaches, such as, but not limited to a mean absolute percentage error (MAPE) and/or root-mean-square error (RMSE).

In some implementations, in reference to FIG. 4, the digital deposit transaction modeling system 106 utilizes known deposit transaction data 414 as ground truth training data for a machine learning based deposit transaction predictor model. For example, the digital deposit transaction modeling system 106 can train the machine learning based deposit transaction predictor model using known deposit transaction data 414 by generating deposit transaction prediction data from user account data (e.g., historical deposit transaction data) and comparing the deposit transaction prediction data to known outcomes (as ground truth data) from the known deposit transaction data 414 (e.g., a known deposit transaction that occurs after the historical deposit transaction data). Indeed, the digital deposit transaction modeling system 106 utilizes the comparison between the predictions and the known deposit transaction data to generate loss values using a loss function of the machine learning based deposit transaction predictor model. Then, the digital deposit transaction modeling system 106 utilizes the loss values to learn or adjust parameters of the machine learning based deposit transaction predictor model (e.g., via backpropagation).

In some cases, the digital deposit transaction modeling system 106 can also utilize confidence scores corresponding to a deposit transaction predictor model to generate a high confidence deposit transaction predictor model. For instance, the digital deposit transaction modeling system 106 can filter parameters or user account data types (e.g., particular types of historical deposit transactions) that result in high confidence scores (e.g., confidence scores that satisfy a determined confidence threshold). Then, the digital deposit transaction modeling system 106 can utilize the deposit transaction predictor model (e.g., the logic of the model) with the filtered parameters and/or user account data types.

In some embodiments, the digital deposit transaction modeling system 106 can determine deposit transaction prediction data for various numbers of deposit transaction sources corresponding to a user account. For example, the digital deposit transaction modeling system 106 can determine a deposit transaction prediction data for multiple, separate deposit transaction sources (e.g., multiple income sources). To illustrate, the digital deposit transaction modeling system 106 can determine groupings of historical deposit transactions based on different transaction sources. Moreover, the digital deposit transaction modeling system 106 can utilize the different groups of historical deposit transactions (e.g., with other user account data) with a deposit transaction predictor model to determine time-based deposit prediction data and/or value-based deposit prediction data (in accordance with one or more implementations herein) for separate deposit transaction sources for a user account.

As mentioned above, the digital deposit transaction modeling system 106 can update a deposit transaction prediction data source with determined deposit transaction data predictions to enable access to the deposit transaction prediction data at various downstream computer-based services (or applications). For example, FIG. 5 illustrates a flow diagram in which the digital deposit transaction modeling system 106 updates a deposit transaction prediction data source(s) with determined deposit transaction data predictions. In addition, FIG. 5 also illustrates the digital deposit transaction modeling system 106 enabling access to the deposit transaction prediction data at various downstream computer-based services (or applications).

For instance, as shown in FIG. 5, the digital deposit transaction modeling system 106 retrieves and utilizes user account data 506 from data storage 502 (e.g., one or more data sources as described above) with a deposit transaction predictor model 508 to generate deposit transaction prediction data 510. Moreover, as shown in FIG. 5, the digital deposit transaction modeling system 106 can publish (or update) the deposit transaction prediction data within a data stream 504 (e.g., a deposit transaction prediction data source as described above). Furthermore, the digital deposit transaction modeling system 106 can enable the data stream 504 can provide the deposit transaction prediction data 510 to downstream services 514a-514n upon receiving one or more deposit transaction prediction data requests 512 (e.g., via a data query service).

As previously mentioned, the digital deposit transaction modeling system 106 can update (or store) deposit transaction prediction data within one or more deposit transaction data sources (as part of a data pipeline). For example, the digital deposit transaction modeling system 106 can store the deposit transaction prediction data within a data storage or repository (e.g., a cloud service). In some cases, the digital deposit transaction modeling system 106 can publish the deposit transaction prediction data as part of a data stream. In some instances, the digital deposit transaction modeling system 106 can publish the deposit transaction prediction data to a deposit transaction prediction data source stream that is accessed for live (or near real time) deposit transaction prediction data (e.g., nearline streaming) or that continuously publishes updated data to downstream services that subscribe to the data stream.

Furthermore, in reference to FIG. 5, the digital deposit transaction modeling system 106 can utilize a data query service to enable downstream services 514a-514n to provide deposit transaction prediction data requests 512 (e.g., data requests) for deposit transaction prediction data 510. In particular, the digital deposit transaction modeling system 106 can utilize various data query services. For example, in one or more embodiments, the digital deposit transaction modeling system 106 can utilize data query service that facilitates the utilization of a programming language (or coding paradigm) to provide instructions to a data source to request data. For example, in some cases, the digital deposit transaction modeling system 106 utilizes an application programming interface (API) that enables standardized language to request deposit transaction prediction data from data sources.

In other cases, the digital deposit transaction modeling system 106 can provide selectable graphical user interface (GUI) options to configure and provide data requests. For instance, the digital deposit transaction modeling system 106 can enable downstream services 514a-514n to display or provide selectable GUI options on administrator devices to enable a selection of one or more data requests for deposit transaction prediction data. Indeed, the digital deposit transaction modeling system 106 can utilize selections from the selectable GUI options as deposit transaction prediction data requests.

Additionally, in one or more embodiments, the digital deposit transaction modeling system 106 transmits (based on the deposit transaction prediction data requests) deposit transaction prediction data to downstream services to enable the downstream services to transform the deposit transaction prediction data. For example, the digital deposit transaction modeling system 106 can enable a downstream service to utilize the deposit transaction prediction data for various functionalities within the downstream service (or application). For example, the digital deposit transaction modeling system 106 can enable a downstream service (e.g., the downstream services 514a-514n) to display elements of the deposit transaction prediction data, utilize the deposit transaction prediction data within a predicted deposit value transaction application, utilize the deposit transaction prediction data within a chatbot service, utilize the deposit transaction prediction data within a payment scheduler application, and/or utilize the deposit transaction prediction data within various analytic tools.

To illustrate, in some cases, the digital deposit transaction modeling system 106 can enable a downstream service (or application) to display various data within graphical user interfaces. For instance, the digital deposit transaction modeling system 106 can enable a downstream service (or application) to display time-based and/or value-based deposit transaction prediction data to one or more user accounts via one or more client devices. Indeed, the digital deposit transaction modeling system 106 can enable the downstream service (or application) to display the deposit transaction prediction data to provide information to users corresponding to the one or more user accounts.

In some embodiments, the digital deposit transaction modeling system 106 can enable a downstream service (or application) to utilize the deposit transaction prediction data within a predicted deposit value transaction application. For instance, the digital deposit transaction modeling system 106 can enable a downstream service (or application) to facilitate access to an available deposit balance within one or more user accounts (e.g., early access to a deposit prior to the predicted deposit transaction) as part of the account value balance in the one or more user accounts. In particular, the digital deposit transaction modeling system 106 can enable the downstream service (or application) to reference the deposit transaction prediction data to determine an available deposit balance and further, receive user selections of a pre-deposit transaction amount, to modify a user account value based on the selected pre-deposit transaction amount.

In some cases, the digital deposit transaction modeling system 106 can enable a downstream service (or application) to utilize the deposit transaction prediction data within a chatbot service. For example, the digital deposit transaction modeling system 106 can enable a downstream service (or application) to provide a chatbot that can answer various questions of a user within a user account. For instance, the digital deposit transaction modeling system 106 can enable a downstream service (or application) chatbot utilize the deposit transaction prediction data to answer queries, such as, but not limited to, “Where is my paycheck?”

In some embodiments, the digital deposit transaction modeling system 106 can enable a downstream service (or application) to utilize the deposit transaction prediction data within a payment scheduler application. For instance, the digital deposit transaction modeling system 106 can enable a downstream service (or application) to set or configure bill payments for a user account based on the deposit transaction prediction data. For instance, the digital deposit transaction modeling system 106 can enable the downstream service (or application) to set or configure bill payments to be on a day or after a day corresponding to a predicted deposit transaction date from the deposit transaction prediction data.

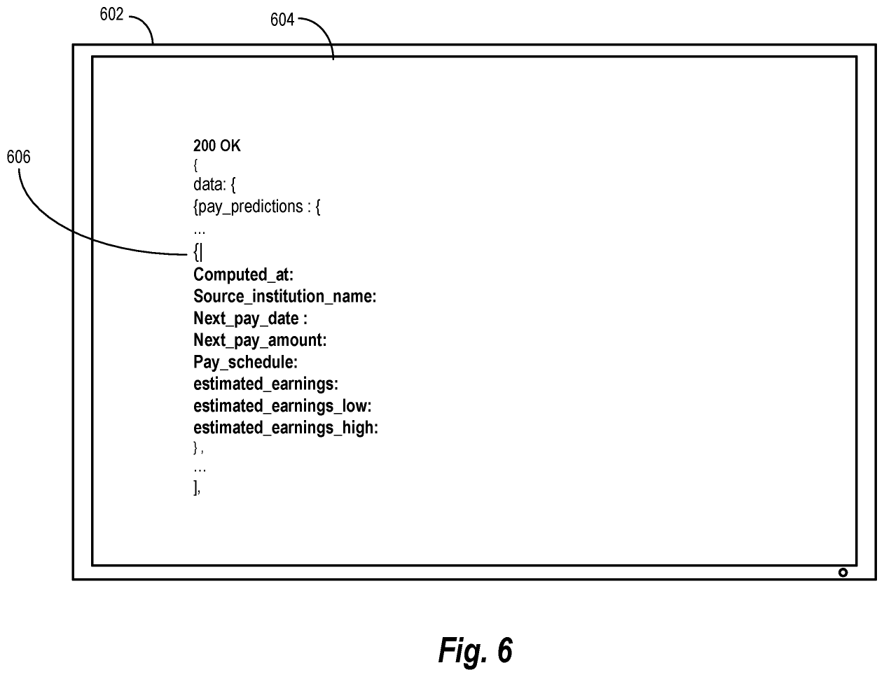

In addition, FIG. 6 illustrates an exemplary deposit transaction prediction data request that includes various data fields from a deposit transaction prediction data source. For example, FIG. 6 illustrates a data request 606 within a graphical user interface 604 of a client device 602). As shown in FIG. 6, the data request 606 includes a request for various types of data from the deposit transaction prediction data source. For instance, the data request 606 includes requests for where the predicted deposit transaction data was computed, a data source name, a next predicted pay date (e.g., a predicted deposit transaction date), a next predicted pay amount (e.g., a predicted deposit transaction amount), a pay schedule (e.g., a predicted deposit transaction frequency), estimated earnings (e.g., an available deposit balance), a range for the estimated earnings (e.g., a minimum and maximum for an available deposit balance).

The digital deposit transaction modeling system 106 can cause a deposit transaction prediction data source to provide data for the specific types of data in response to such a data request. Indeed, in one or more embodiments, the digital deposit transaction modeling system 106 can enable a deposit transaction prediction data source to provide data for the specific types of data, such as, but not limited to, user identifiers, deposit transaction sources to request predicted deposit transaction data for specific deposit transaction sources, user account data extraction date and/or timestamps, prediction computation date and/or timestamps, last deposit transaction timestamp, last deposit transaction amount, deposit transaction count, next predicted deposit transaction, next predicted deposit transaction amount or amount range, predicted deposit transaction frequency, predicted available deposit balance or range of available deposit balance, deposit transaction predictor model version, confidence score for user account, confidence score category or grouping of user account, next predicted deposit transaction confidence score (or group confidence score), and/or next predicted deposit transaction amount or amount range confidence score (or group confidence score).

In addition, the digital deposit transaction modeling system 106 can also enable a deposit transaction prediction data source to provide data for specific types of data corresponding to prediction, model accuracy, and/or model data, such as, but not limited to, deposit transaction predictor model version information, training count, prediction count, percentages of accurate date predictions, percentages of accurate amount predictions, error percentages corresponding to date and/or value predictions, input data cutoff timestamps, computation timestamps, upper and/or lower bounds of date and/or value predictions, and/or accuracy criterion ranges utilized.

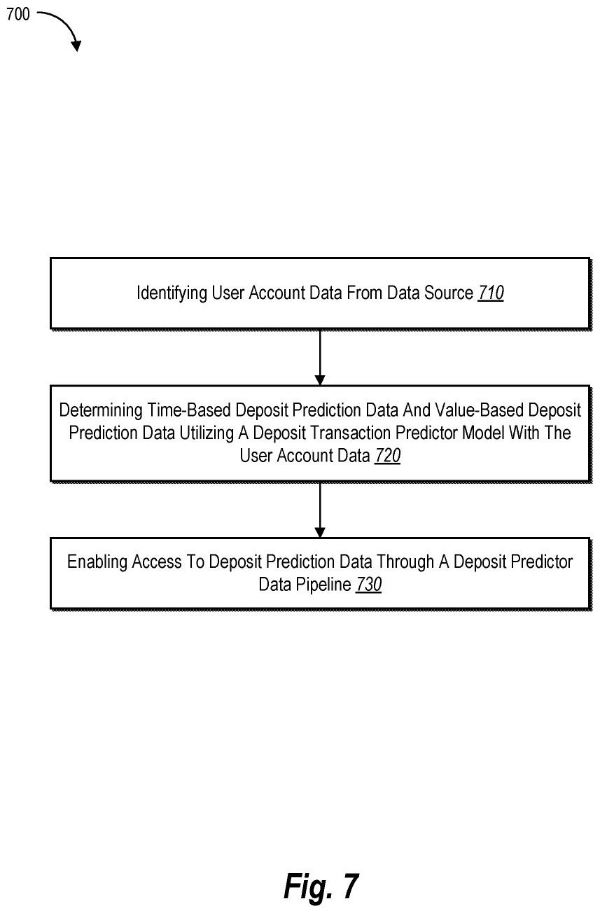

Turning now to FIG. 7, this figure shows a flowchart of a series of acts 700 for utilizing a deposit transaction predictor model to facilitate downstream access to deposit transaction prediction data through a data pipeline in accordance with one or more implementations. While FIG. 7 illustrates acts according to one embodiment, alternative embodiments may omit, add to, reorder, and/or modify any of the acts shown in FIG. 7. The acts of FIG. 7 can be performed as part of a method. Alternatively, a non-transitory computer readable storage medium can comprise instructions that, when executed by the one or more processors, cause a computing device to perform the acts depicted in FIG. 7. In still further embodiments, a system can perform the acts of FIG. 7.

As shown in FIG. 7, the series of acts 700 include an act 710 of identifying user account data from a data source. For example, the act 710 can include identifying user account data for a user account from one or more data sources. In some cases, user account data can include historical deposit transaction data corresponding to a user account, geo-location data from a client device corresponding to the user account, and/or deposit transaction source information corresponding to the user account. Moreover, the act 710 can include identifying user account data by utilizing a data pipeline to receive data from one or more data sources. For example, a data source can include a client device corresponding to the user account, a computer network corresponding to a deposit transaction source, or a user account transaction activity data repository.

As also shown in FIG. 7, the series of acts 700 include an act 720 of determining time-based deposit prediction data and value-based deposit prediction data utilizing a deposit transaction predictor model with user account data. For instance, the act 720 can include determining, for a user account, time-based deposit prediction data and value-based deposit prediction data utilizing user account data with a deposit transaction predictor model. In some cases, the act 720 can include utilizing a deposit transaction predictor model with user account data to determine one or more predicted dates for one or more predicted deposit transactions or a predicted frequency for the one or more predicted deposit transactions as time-based deposit prediction data. Moreover, the act 720 can include utilizing a deposit transaction predictor model with user account data to determine one or more predicted deposit transaction monetary amounts for one or more predicted deposit transactions as value-based deposit prediction data.

In some embodiments, the act 720 includes utilizing a deposit transaction predictor model with user account data to determine a predicted deposit transaction rate based on time-based deposit prediction data and one or more predicted deposit transaction monetary amounts. Furthermore, the act 720 can include determining an available deposit balance for a user account as a value-based deposit prediction data utilizing a predicted deposit transaction rate and a historical deposit transaction date from a user account.

Moreover, the act 720 can include utilizing a deposit transaction time predictor model (as part of a deposit transaction predictor model) to determine one or more deposit transaction date patterns from historical deposit transaction dates of a user account. Additionally, the act 720 can include utilizing a deposit transaction value predictor model to determine one or more deposit transaction amount patterns from historical deposit transaction amounts of a user account and outlier detection logic. Additionally, the act 720 can include adjusting one or more parameters for a deposit transaction predictor model based on a comparison of time-based deposit prediction data or value-based deposit prediction data with historical deposit transaction data.

As shown in FIG. 7, the series of acts 700 include an act 730 of enabling access to deposit prediction data through a deposit predictor data pipeline. For example, the act 730 can include updating a deposit transaction prediction data source with time-based deposit prediction data and value-based deposit prediction data. Furthermore, the act 730 can include, based on receiving a data request for a deposit transaction prediction data source from a downstream computer network device, providing time-based deposit prediction data or value-based deposit prediction data from the deposit transaction prediction data source to the downstream computer network device. Moreover, the act 730 can include receiving a data request for time-based deposit prediction data or value-based deposit prediction data through an application programming interface (API) for a deposit transaction prediction data source. Additionally, the act 730 can include providing time-based deposit prediction data or value-based deposit prediction data from a deposit transaction prediction data source to cause a downstream computer network device to display the time-based deposit prediction data or the value-based deposit prediction data within a graphical user interface for a predicted deposit value transaction application, a chatbot service application, or a payment scheduler application.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system, including by one or more servers. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, virtual reality devices, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 8 illustrates, in block diagram form, an exemplary computing device 800 that may be configured to perform one or more of the processes described above. One will appreciate that the digital deposit transaction modeling system 106 (or the inter-network facilitation system 104) can comprise implementations of a computing device, including, but not limited to, the devices or systems illustrated in the previous figures. As shown by FIG. 8, the computing device can comprise a processor 802, memory 804, a storage device 806, an I/O interface 808, and a communication interface 810. In certain embodiments, the computing device 800 can include fewer or more components than those shown in FIG. 8. Components of computing device 800 shown in FIG. 8 will now be described in additional detail.

In particular embodiments, processor(s) 802 includes hardware for executing instructions, such as those making up a computer program. As an example, and not by way of limitation, to execute instructions, processor(s) 802 may retrieve (or fetch) the instructions from an internal register, an internal cache, memory 804, or a storage device 806 and decode and execute them.

The computing device 800 includes memory 804, which is coupled to the processor(s) 802. The memory 804 may be used for storing data, metadata, and programs for execution by the processor(s). The memory 804 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 804 may be internal or distributed memory.

The computing device 800 includes a storage device 806 includes storage for storing data or instructions. As an example, and not by way of limitation, storage device 806 can comprise a non-transitory storage medium described above. The storage device 806 may include a hard disk drive (“HDD”), flash memory, a Universal Serial Bus (“USB”) drive or a combination of these or other storage devices.

The computing device 800 also includes one or more input or output (“I/O”) interface 808, which are provided to allow a user (e.g., requester or provider) to provide input to (such as user strokes), receive output from, and otherwise transfer data to and from the computing device 800. These I/O interface 808 may include a mouse, keypad or a keyboard, a touch screen, camera, optical scanner, network interface, modem, other known I/O devices or a combination of such I/O interface 808. The touch screen may be activated with a stylus or a finger.

The I/O interface 808 may include one or more devices for presenting output to a user, including, but not limited to, a graphics engine, a display (e.g., a display screen), one or more output providers (e.g., display providers), one or more audio speakers, and one or more audio providers. In certain embodiments, the I/O interface 808 is configured to provide graphical data to a display for presentation to a user. The graphical data may be representative of one or more graphical user interfaces and/or any other graphical content as may serve a particular implementation.

The computing device 800 can further include a communication interface 810. The communication interface 810 can include hardware, software, or both. The communication interface 810 can provide one or more interfaces for communication (such as, for example, packet-based communication) between the computing device and one or more other computing devices 800 or one or more networks. As an example, and not by way of limitation, communication interface 810 may include a network interface controller (“NIC”) or network adapter for communicating with an Ethernet or other wire-based network or a wireless NIC (“WNIC”) or wireless adapter for communicating with a wireless network, such as a WI-FI. The computing device 800 can further include a bus 812. The bus 812 can comprise hardware, software, or both that couples components of computing device 800 to each other.

FIG. 9 illustrates an example network environment 900 of the inter-network facilitation system 104. The network environment 900 includes a client device 906 (e.g., client devices 112a-112n and/or administrator device 116), an inter-network facilitation system 104, and a third-party system 908 connected to each other by a network 904. Although FIG. 9 illustrates a particular arrangement of the client device 906, the inter-network facilitation system 104, the third-party system 908, and the network 904, this disclosure contemplates any suitable arrangement of client device 906, the inter-network facilitation system 104, the third-party system 908, and the network 904. As an example, and not by way of limitation, two or more of client device 906, the inter-network facilitation system 104, and the third-party system 908 communicate directly, bypassing network 904. As another example, two or more of client device 906, the inter-network facilitation system 104, and the third-party system 908 may be physically or logically co-located with each other in whole or in part.

Moreover, although FIG. 9 illustrates a particular number of client devices 906, inter-network facilitation system 104, third-party systems 908, and networks 904, this disclosure contemplates any suitable number of client devices 906, FIG. 9, third-party systems 908, and networks 904. As an example, and not by way of limitation, network environment 900 may include multiple client devices 906, inter-network facilitation system 104, third-party systems 908, and/or networks 904.

This disclosure contemplates any suitable network 904. As an example, and not by way of limitation, one or more portions of network 904 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 904 may include one or more networks 904.

Links may connect client device 906, inter-network facilitation system 104 (e.g., which hosts the digital deposit transaction modeling system 106), and third-party system 908 to network 904 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 900. One or more first links may differ in one or more respects from one or more second links.

In particular embodiments, the client device 906 may be an electronic device including hardware, software, or embedded logic components or a combination of two or more such components and capable of carrying out the appropriate functionalities implemented or supported by client device 906. As an example, and not by way of limitation, a client device 906 may include any of the computing devices discussed above in relation to FIG. 8. A client device 906 may enable a network user at the client device 906 to access network 904. A client device 906 may enable its user to communicate with other users at other client devices 906.

In particular embodiments, the client device 906 may include a requester application or a web browser, such as MICROSOFT INTERNET EXPLORER, GOOGLE CHROME, or MOZILLA FIREFOX, and may have one or more add-ons, plug-ins, or other extensions, such as TOOLBAR or YAHOO TOOLBAR. A user at the client device 906 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 906 one or more Hyper Text Markup Language (“HTML”) files responsive to the HTTP request. The client device 906 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, inter-network facilitation system 104 may be a network-addressable computing system that can interface between two or more computing networks or servers associated with different entities such as financial institutions (e.g., banks, credit processing systems, ATM systems, or others). In particular, the inter-network facilitation system 104 can send and receive network communications (e.g., via the network 904) to link the third-party-system 908. For example, the inter-network facilitation system 104 may receive authentication credentials from a user to link a third-party system 908 such as an online bank account, credit account, debit account, or other financial account to a user account within the inter-network facilitation system 104. The inter-network facilitation system 104 can subsequently communicate with the third-party system 908 to detect or identify balances, transactions, withdrawal, transfers, deposits, credits, debits, or other transaction types associated with the third-party system 908. The inter-network facilitation system 104 can further provide the aforementioned or other financial information associated with the third-party system 908 for display via the client device 906. In some cases, the inter-network facilitation system 104 links more than one third-party system 908, receiving account information for accounts associated with each respective third-party system 908 and performing operations or transactions between the different systems via authorized network connections.

In particular embodiments, the inter-network facilitation system 104 may interface between an online banking system and a credit processing system via the network 904. For example, the inter-network facilitation system 104 can provide access to a bank account of a third-party system 908 and linked to a user account within the inter-network facilitation system 104. Indeed, the inter-network facilitation system 104 can facilitate access to, and transactions to and from, the bank account of the third-party system 908 via a client application of the inter-network facilitation system 104 on the client device 906. The inter-network facilitation system 104 can also communicate with a credit processing system, an ATM system, and/or other financial systems (e.g., via the network 904) to authorize and process credit charges to a credit account, perform ATM transactions, perform transfers (or other transactions) across accounts of different third-party systems 908, and to present corresponding information via the client device 906.

In particular embodiments, the inter-network facilitation system 104 includes a model for approving or denying transactions. For example, the inter-network facilitation system 104 includes a transaction approval machine learning model that is trained based on training data such as user account information (e.g., name, age, location, and/or income), account information (e.g., current balance, average balance, maximum balance, and/or minimum balance), credit usage, and/or other transaction history. Based on one or more of these data (from the inter-network facilitation system 104 and/or one or more third-party systems 908), the inter-network facilitation system 104 can utilize the transaction approval machine learning model to generate a prediction (e.g., a percentage likelihood) of approval or denial of a transaction (e.g., a withdrawal, a transfer, or a purchase) across one or more networked systems.

The inter-network facilitation system 104 may be accessed by the other components of network environment 900 either directly or via network 904. In particular embodiments, the inter-network facilitation system 104 may include one or more servers. Each server may be a unitary server or a distributed server spanning multiple computers or multiple datacenters.

Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by the server. In particular embodiments, the inter-network facilitation system 104 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 906, or an inter-network facilitation system 104 to manage, retrieve, modify, add, or delete, the information stored in a data store.

In particular embodiments, the inter-network facilitation system 104 may provide users with the ability to take actions on various types of items or objects, supported by the inter-network facilitation system 104. As an example, and not by way of limitation, the items and objects may include financial institution networks for banking, credit processing, or other transactions, to which users of the inter-network facilitation system 104 may belong, computer-based applications that a user may use, transactions, interactions that a user may perform, or other suitable items or objects. A user may interact with anything that is capable of being represented in the inter-network facilitation system 104 or by an external system of a third-party system, which is separate from inter-network facilitation system 104 and coupled to the inter-network facilitation system 104 via a network 904.

In particular embodiments, the inter-network facilitation system 104 may be capable of linking a variety of entities. As an example, and not by way of limitation, the inter-network facilitation system 104 may enable users to interact with each other or other entities, or to allow users to interact with these entities through an application programming interfaces (“API”) or other communication channels.

In particular embodiments, the inter-network facilitation system 104 may include a variety of servers, sub-systems, programs, modules, logs, and data stores. In particular embodiments, the inter-network facilitation system 104 may include one or more of the following: a web server, action logger, API-request server, transaction engine, cross-institution network interface manager, notification controller, action log, third-party-content-object-exposure log, inference module, authorization/privacy server, search module, user-interface module, user-profile (e.g., provider profile or requester profile) store, connection store, third-party content store, or location store. The inter-network facilitation system 104 may also include suitable components such as network interfaces, security mechanisms, load balancers, failover servers, management-and-network-operations consoles, other suitable components, or any suitable combination thereof. In particular embodiments, the inter-network facilitation system 104 may include one or more user-profile stores for storing user profiles for transportation providers and/or transportation requesters. A user profile may include, for example, biographic information, demographic information, financial information, behavioral information, social information, or other types of descriptive information, such as interests, affinities, or location.

The web server may include a mail server or other messaging functionality for receiving and routing messages between the inter-network facilitation system 104 and one or more client devices 906. An action logger may be used to receive communications from a web server about a user's actions on or off the inter-network facilitation system 104. In conjunction with the action log, a third-party-content-object log may be maintained of user exposures to third-party-content objects. A notification controller may provide information regarding content objects to a client device 906. Information may be pushed to a client device 906 as notifications, or information may be pulled from client device 906 responsive to a request received from client device 906. Authorization servers may be used to enforce one or more privacy settings of the users of the inter-network facilitation system 104. A privacy setting of a user determines how particular information associated with a user can be shared. The authorization server may allow users to opt in to or opt out of having their actions logged by the inter-network facilitation system 104 or shared with other systems, such as, for example, by setting appropriate privacy settings. Third-party-content-object stores may be used to store content objects received from third parties. Location stores may be used for storing location information received from client devices 906 associated with users.

In addition, the third-party system 908 can include one or more computing devices, servers, or sub-networks associated with internet banks, central banks, commercial banks, retail banks, credit processors, credit issuers, ATM systems, credit unions, loan associates, brokerage firms, linked to the inter-network facilitation system 104 via the network 904. A third-party system 908 can communicate with the inter-network facilitation system 104 to provide financial information pertaining to balances, transactions, and other information, whereupon the inter-network facilitation system 104 can provide corresponding information for display via the client device 906. In particular embodiments, a third-party system 908 communicates with the inter-network facilitation system 104 to update account balances, transaction histories, credit usage, and other internal information of the inter-network facilitation system 104 and/or the third-party system 908 based on user interaction with the inter-network facilitation system 104 (e.g., via the client device 906). Indeed, the inter-network facilitation system 104 can synchronize information across one or more third-party systems 908 to reflect accurate account information (e.g., balances, transactions, etc.) across one or more networked systems, including instances where a transaction (e.g., a transfer) from one third-party system 908 affects another third-party system 908.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
identifying user account data for a user account from one or more data sources;
determining, for the user account, time-based deposit prediction data and value-based deposit prediction data utilizing the user account data with a deposit transaction predictor model;
updating a deposit transaction prediction data source with the time-based deposit prediction data and the value-based deposit prediction data; and
based on receiving a data request for the deposit transaction prediction data source from a downstream computer network device, providing the time-based deposit prediction data or the value-based deposit prediction data from the deposit transaction prediction data source to the downstream computer network device.

2. The computer-implemented method of claim 1, wherein the user account data comprises historical deposit transaction data corresponding to the user account, geo-location data from a client device corresponding to the user account, or deposit transaction source information corresponding to the user account.

3. The computer-implemented method of claim 1, further comprising identifying the user account data by utilizing a data pipeline to receive data from the one or more data sources, wherein the one or more data sources comprise a client device corresponding to the user account, a computer network corresponding to a deposit transaction source, or a user account transaction activity data repository.

4. The computer-implemented method of claim 1, further comprising utilizing the deposit transaction predictor model with the user account data to determine one or more predicted dates for one or more predicted deposit transactions or a predicted frequency for the one or more predicted deposit transactions as the time-based deposit prediction data.

5. The computer-implemented method of claim 1, further comprising utilizing the deposit transaction predictor model with the user account data to determine one or more predicted deposit transaction monetary amounts for one or more predicted deposit transactions as the value-based deposit prediction data.

6. The computer-implemented method of claim 5, further comprising:
utilizing the deposit transaction predictor model with the user account data to determine a predicted deposit transaction rate based on the time-based deposit prediction data and the one or more predicted deposit transaction monetary amounts; and
determining an available deposit balance for the user account as the value-based deposit prediction data utilizing the predicted deposit transaction rate and a historical deposit transaction date from the user account.

7. The computer-implemented method of claim 1, further comprising utilizing the deposit transaction predictor model to:
utilize a deposit transaction time predictor model to determine one or more deposit transaction date patterns from historical deposit transaction dates of the user account; and
utilize a deposit transaction value predictor model to determine one or more deposit transaction amount patterns from historical deposit transaction amounts of the user account and outlier detection logic.

8. The computer-implemented method of claim 7, further comprising adjusting one or more parameters for the deposit transaction predictor model based on a comparison of the time-based deposit prediction data or the value-based deposit prediction data with historical deposit transaction data.

9. The computer-implemented method of claim 1, further comprising receiving the data request for the time-based deposit prediction data or the value-based deposit prediction data through an application programming interface (API) for the deposit transaction prediction data source.

10. The computer-implemented method of claim 1, further comprising providing the time-based deposit prediction data or the value-based deposit prediction data from the deposit transaction prediction data source to cause the downstream computer network device to display the time-based deposit prediction data or the value-based deposit prediction data within a graphical user interface for a predicted deposit value transaction application, a chatbot service application, or a payment scheduler application.

11. A non-transitory computer-readable medium storing instructions that, when executed by at least one processor, cause a computing device to:
identify user account data for a user account from one or more data sources;
determine, for the user account, time-based deposit prediction data and value-based deposit prediction data utilizing the user account data with a deposit transaction predictor model;
update a deposit transaction prediction data source with the time-based deposit prediction data and the value-based deposit prediction data; and
based on receiving a data request for the deposit transaction prediction data source from a downstream computer network device, provide the time-based deposit prediction data or the value-based deposit prediction data from the deposit transaction prediction data source to the downstream computer network device.

12. The non-transitory computer-readable medium of claim 11, wherein the user account data comprises historical deposit transaction data corresponding to the user account, geo-location data from a client device corresponding to the user account, or deposit transaction source information corresponding to the user account.

13. The non-transitory computer-readable medium of claim 11, further comprising instructions that, when executed by the at least one processor, cause the computing device to identify the user account data by utilizing a data pipeline to receive data from the one or more data sources, wherein the one or more data sources comprise a client device corresponding to the user account, a computer network corresponding to a deposit transaction source, or a user account transaction activity data repository.

14. The non-transitory computer-readable medium of claim 11, further comprising instructions that, when executed by the at least one processor, cause the computing device to utilize the deposit transaction predictor model with the user account data to determine one or more predicted dates for one or more predicted deposit transactions or a predicted frequency for the one or more predicted deposit transactions as the time-based deposit prediction data.

15. The non-transitory computer-readable medium of claim 11, further comprising instructions that, when executed by the at least one processor, cause the computing device to utilize the deposit transaction predictor model with the user account data to determine one or more predicted deposit transaction monetary amounts for one or more predicted deposit transactions as the value-based deposit prediction data.

16. The non-transitory computer-readable medium of claim 15, further comprising instructions that, when executed by the at least one processor, cause the computing device to:
utilize the deposit transaction predictor model with the user account data to determine a predicted deposit transaction rate based on the time-based deposit prediction data and the one or more predicted deposit transaction monetary amounts; and
determine an available deposit balance for the user account as the value-based deposit prediction data utilizing the predicted deposit transaction rate and a historical deposit transaction date from the user account.

17. A system comprising:
at least one processor; and
at least one non-transitory computer-readable storage medium storing instructions that, when executed by the at least one processor, cause the system to:
identify user account data for a user account from one or more data sources;
determine, for the user account, time-based deposit prediction data and value-based deposit prediction data utilizing the user account data with a deposit transaction predictor model;
update a deposit transaction prediction data source with the time-based deposit prediction data and the value-based deposit prediction data; and
based on receiving a data request for the deposit transaction prediction data source from a downstream computer network device, provide the time-based deposit prediction data or the value-based deposit prediction data from the deposit transaction prediction data source to the downstream computer network device.

18. The system of claim 17, further comprising instructions that, when executed by the at least one processor, cause the system to identify the user account data by utilizing a data pipeline to receive data from the one or more data sources, wherein the one or more data sources comprise a client device corresponding to the user account, a computer network corresponding to a deposit transaction source, or a user account transaction activity data repository, wherein the user account data comprises historical deposit transaction data corresponding to the user account, geo-location data from a client device corresponding to the user account, or deposit transaction source information corresponding to the user account.

19. The system of claim 17, further comprising instructions that, when executed by the at least one processor, cause the system to utilize the deposit transaction predictor model with the user account data to determine one or more predicted dates for one or more predicted deposit transactions or a predicted frequency for the one or more predicted deposit transactions as the time-based deposit prediction data.

20. The system of claim 17, further comprising instructions that, when executed by the at least one processor, cause the system to utilize the deposit transaction predictor model to:
utilize a deposit transaction time predictor model to determine one or more deposit transaction date patterns from historical deposit transaction dates of the user account; and
utilize a deposit transaction value predictor model to determine one or more deposit transaction amount patterns from historical deposit transaction amounts of the user account and outlier detection logic.
